(19) United States
(12) Patent Application Publication
(10) Pub. No.: US 2025/0358039 A1
(43) Pub. Date: Nov. 20, 2025

(54) APPROXIMATION SCHEMES USING FUNCTIONAL FITTING IN CONSTELLATION SHAPING

(71) Applicant: QUALCOMM Incorporated, San Diego, CA (US)

(72) Inventors: Wei LIU, Beijing (CN); Thomas Joseph RICHARDSON, South Orange, NJ (US); Changlong XU, Beijing (CN); Hao XU, Beijing (CN)

(21) Appl. No.: 18/871,403

(22) PCT Filed: Jul. 18, 2022
(86) PCT No.: PCT/CN2022/106176

§ 371 Date: Dec. 3, 2024

(51) Int. Cl. H04L 1/00

(52) U.S. Cl. CPC H04L 1/0007; H04L 1/0042; H04L 1/0047; H04L 1/0058

(57) ABSTRACT

A wireless communication device configured with approximation schemes utilizing functional fitting in constellation shaping is disclosed. The device is configured to obtain subintervals over which to form piecewise polynomial approximations of a plurality of terms, obtain, utilizing the piecewise polynomial approximations of the plurality of terms, an approximation of a total number of first symbol sequences over a first alphabet having a first alphabet size, each respective symbol sequence of the total number of first symbol sequences having a first symbol sequence length and a first symbol sequence energy, obtain a bit sequence having a bit sequence length, encode the bit sequence, utilizing the approximation of the total number of first symbol sequences, to a second symbol sequence over a second alphabet having a second alphabet size, the second symbol sequence having a second symbol sequence length and a second symbol sequence energy, and transmit the second symbol sequence.

### TECHNICAL FIELD

The technology discussed below relates generally to wireless communication systems and, more particularly, to approximation schemes using functional fitting in constellation shaping.

### INTRODUCTION

In current wireless communication systems such as 5G New Radio (NR), higher-order quadrature amplitude modulation (QAM) schemes (e.g., 16QAM, 64QAM, and 256QAM) are used. The constellations associated with these QAM schemes are fixed and each constellation point is used with equal probability. Channel capacity with these schemes may be large compared, for example, to binary phase shift keying (BPSK) modulation. Techniques may be used to shape the constellations to improve transmission rates.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

In one example, a wireless communication device is disclosed. The wireless communication device includes a wireless transceiver, a memory, and a processor coupled to the wireless transceiver and the memory. In the example, the processor and the memory are configured to: obtain subintervals over which to form piecewise polynomial approximations of a plurality of terms, obtain, utilizing the piecewise polynomial approximations of the plurality of terms, an approximation of a total number of first symbol sequences over a first alphabet having a first alphabet size, each respective symbol sequence of the total number of first symbol sequences having a first symbol sequence length and a first symbol sequence energy, obtain a bit sequence having a bit sequence length, encode the bit sequence, utilizing the approximation of the total number of first symbol sequences, to a second symbol sequence over a second alphabet having a second alphabet size, the second symbol sequence having a second symbol sequence length and a second symbol sequence energy, and transmit the second symbol sequence via the wireless transceiver.

In another example, a method at a wireless communication device is disclosed. The method includes obtaining subintervals over which to form piecewise polynomial approximations of a plurality of terms, obtaining, utilizing the piecewise polynomial approximations of the plurality of terms, an approximation of a total number of first symbol sequences over a first alphabet having a first alphabet size, each respective symbol sequence of the total number of first symbol sequences having a first symbol sequence length and a first symbol sequence energy, obtaining a bit sequence having a bit sequence length, encoding the bit sequence, utilizing the approximation of the total number of first symbol sequences, to a second symbol sequence over a second alphabet having a second alphabet size and having a second symbol sequence length and a second symbol sequence energy, and transmitting the second symbol sequence.

In one aspect, a wireless communication device includes means for obtaining subintervals over which to form piecewise polynomial approximations of a plurality of terms, means for obtaining, utilizing the piecewise polynomial approximations of the plurality of terms, an approximation of a total number of first symbol sequences over a first alphabet having a first alphabet size, each respective symbol sequence of the total number of first symbol sequences having a first symbol sequence length and a first symbol sequence energy, means for obtaining a bit sequence having a bit sequence length, means for encoding the bit sequence, utilizing the approximation of the total number of first symbol sequences, to a second symbol sequence over a second alphabet having a second alphabet size and having a second symbol sequence length and a second symbol sequence energy, and means for transmitting the second symbol sequence.

These and other aspects will become more fully understood upon a review of the detailed description, which follows. Other aspects, features, and examples will become apparent to those of ordinary skill in the art upon reviewing the following description of specific exemplary aspects in conjunction with the accompanying figures. While features may be discussed relative to certain examples and figures below, all examples can include one or more of the advantageous features discussed herein. In other words, while one or more examples may be discussed as having certain advantageous features, one or more of such features may also be used in accordance with the various examples discussed herein. Similarly, while examples may be discussed below as device, system, or method examples, it should be understood that such examples can be implemented in various devices, systems, and methods.

### BRIEF DESCRIPTION OF THE DRAWINGS

FIG. 1 is a schematic illustration of a wireless communication system according to some aspects of the disclosure.

FIG. 2 is a schematic illustration of an example of a radio access network (RAN) according to some aspects of the disclosure.

FIG. 3 is an expanded view of an exemplary subframe, showing an orthogonal frequency divisional multiplexing (OFDM) resource grid according to some aspects of the disclosure.

FIG. 4 is a block diagram illustrating one example of a transmitter chain and a receiver chain of a wireless communication device having a probabilistic amplitude shaping architecture according to some aspects of the disclosure.

FIG. 5A is a first plot of signal-to-noise ratio (SNR) as a function of uniformly distributed amplitude-shift keying (ASK) constellations according to some aspects of the disclosure.

FIG. 5B is a second plot of SNR as a function of optimal Maxwell-Boltzmann distributed constellations according to some aspects of the disclosure.

FIG. 6 is a three-dimensional depiction of log N^{[m]}(n, E) as a function of n and E, according to some aspects of the disclosure.

FIG. 7 is a graph depicting the logarithm of 1024 multiplied by the absolute error |H(ω)−Ĥ(ω)| under base 10 as a function of w according to some aspects of the disclosure.

FIG. 8 is a graph depicting the logarithm of the absolute error |logV(ω)− [symbol] (ω)| under base 10 as a function of ω according to some aspects of the disclosure.

FIG. 9 is one example of a binary tree structure for logV according to some aspects of the disclosure.

FIG. 10 provides one example of a look-up table storing polynomial coefficients for log V according to some aspects of the disclosure.

FIG. 11 provides one example of an access and evaluation process according to some aspects of the disclosure.

FIG. 12 is one example of a look-up table for log V according to some aspects of the disclosure.

FIG. 13 is a block diagram illustrating an example of a hardware implementation of a wireless communication device employing a processing system according to some aspects of the disclosure.

FIG. 14 is a flow chart illustrating an exemplary process at a wireless communication device in a wireless communication network according to some aspects of the disclosure.

FIG. 15 is a flow chart illustrating an exemplary process at a wireless communication device in a wireless communication network according to some aspects of the disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some examples, well known structures and components are shown in block diagram form in order to avoid obscuring such concepts.

While aspects and examples are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip examples and other non-module-component based devices (e.g., end-user devices, vehicles, communication devices, computing devices, industrial equipment, retail/purchasing devices, medical devices, AI-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described examples. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, disaggregated arrangements (e.g., base station and/or user equipment (UE)), end-user devices, etc. of varying sizes, shapes, and constitution.

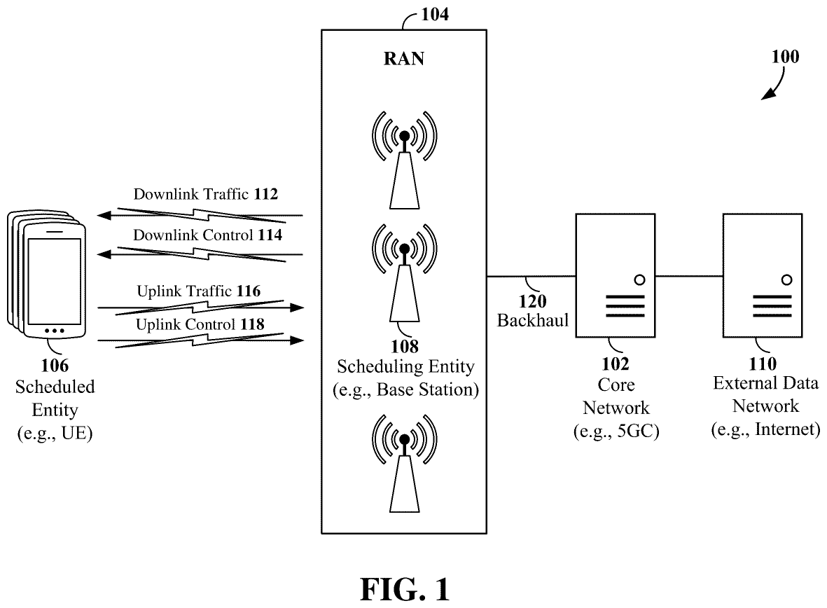

The various concepts presented throughout this disclosure may be implemented across a broad variety of telecommunication systems, network architectures, and communication standards. Referring now to FIG. 1, as an illustrative example without limitation, various aspects of the present disclosure are illustrated with reference to a wireless communication system 100. The wireless communication system 100 includes three interacting domains: a core network 102, a radio access network (RAN) 104, and a user equipment (UE) 106. By virtue of the wireless communication system 100, the UE 106 may be enabled to carry out data communication with an external data network 110, such as (but not limited to) the Internet.

The RAN 104 may implement any suitable wireless communication technology or technologies to provide radio access to the UE 106. As one example, the RAN 104 may operate according to 3rd Generation Partnership Project (3GPP) New Radio (NR) specifications, often referred to as 5G. As another example, the RAN 104 may operate under a hybrid of 5G NR and Evolved Universal Terrestrial Radio Access Network (CUTRAN) standards, often referred to as Long Term Evolution (LTE). The 3GPP refers to this hybrid RAN as a next-generation RAN, or NG-RAN. Of course, many other examples may be utilized within the scope of the present disclosure.

As illustrated, the RAN 104 includes a plurality of base stations 108. Broadly, a base station is a network element in a radio access network responsible for radio transmission and reception in one or more cells to or from a UE. In different technologies, standards, or contexts, a base station may variously be referred to by those skilled in the art as a base transceiver station (BTS), a radio base station, a radio transceiver, a transceiver function, a basic service set (BSS), an extended service set (ESS), an access point (AP), a Node B (NB), an eNode B (cNB), a gNode B (gNB), a transmission and reception point (TRP), or some other suitable terminology. In some examples, a base station may include two or more TRPs that may be collocated or non-collocated. Each TRP may communicate on the same or different carrier frequency within the same or different frequency band. In examples where the RAN 104 operates according to both the LTE and 5G NR standards, one of the base stations may be an LTE base station, while another base station may be a 5G NR base station.

The RAN 104 is further illustrated supporting wireless communication for multiple mobile apparatuses. A mobile apparatus may be referred to as user equipment (UE) in 3GPP standards, but may also be referred to by those skilled in the art as a mobile station (MS), a subscriber station, a mobile unit, a subscriber unit, a wireless unit, a remote unit, a mobile device, a wireless device, a wireless communication device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus (e.g., a mobile apparatus) that provides a user with access to network services.

Within the present disclosure, a “mobile” apparatus need not necessarily have a capability to move and may be stationary. The term mobile apparatus or mobile device broadly refers to a diverse array of devices and technologies. UEs may include a number of hardware structural components sized, shaped, and arranged to help in communication; such components can include antennas, antenna arrays, RF-chains, amplifiers, one or more processors, etc. electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of Things” (IoT).

A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc., an industrial automation and enterprise device, a logistics controller, and/or agricultural equipment, etc. Still further, a mobile apparatus may provide for connected medicine or telemedicine support, e.g., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Wireless communication between the RAN 104 and the UE 106 may be described as utilizing an air interface. Transmissions over the air interface from a base station (e.g., base station 108) to one or more UEs (e.g., similar to UE 106) may be referred to as downlink (DL) transmission. In accordance with certain aspects of the present disclosure, the term downlink may refer to a point-to-multipoint transmission originating at a base station (e.g., base station 108). Another way to describe this scheme may be to use the term broadcast channel multiplexing. Transmissions from a UE (e.g., UE 106) to a base station (e.g., base station 108) may be referred to as uplink (UL) transmissions. In accordance with further aspects of the present disclosure, the term uplink may refer to a point-to-point transmission originating at a UE (e.g., UE 106).

In some examples, access to the air interface may be scheduled, wherein a scheduling entity (e.g., a base station 108) allocates resources for communication among some or all devices and equipment within its service area or cell. Within the present disclosure, as discussed further below, the scheduling entity may be responsible for scheduling, assigning, reconfiguring, and releasing resources for one or more scheduled entities (e.g., UEs 106). That is, for scheduled communication, a plurality of UEs 106, which may be scheduled entities, may utilize resources allocated by the scheduling entity 108.

Base stations 108 are not the only entities that may function as scheduling entities. That is, in some examples, a UE may function as a scheduling entity, scheduling resources for one or more scheduled entities (e.g., one or more other UEs). For example, UEs may communicate directly with other UEs in a peer-to-peer or device-to-device fashion and/or in a relay configuration.

As illustrated in FIG. 1, a scheduling entity 108 may broadcast downlink traffic 112 to one or more scheduled entities (e.g., one or more UEs 106). Broadly, the scheduling entity 108 is a node or device responsible for scheduling traffic in a wireless communication network, including the downlink traffic 112 and, in some examples, uplink traffic 116 from one or more scheduled entities (e.g., one or more UEs 106) to the scheduling entity 108. On the other hand, the scheduled entity (e.g., a UE 106) is a node or device that receives downlink control 114 information, including but not limited to scheduling information (e.g., a grant), synchronization or timing information, or other control information from another entity in the wireless communication network such as the scheduling entity 108. The scheduled entity 106 may further transmit uplink control 118 information, including but not limited to a scheduling request or feedback information, or other control information to the scheduling entity 108.

In addition, the uplink control 118 and/or downlink control 114 information and/or uplink traffic 116 and/or downlink traffic 112 may be transmitted on a waveform that may be time-divided into frames, subframes, slots, and/or symbols. As used herein, a symbol may refer to a unit of time that, in an orthogonal frequency division multiplexed (OFDM) waveform, carries one resource element (RE) per sub-carrier. A slot may carry 7 or 14 OFDM symbols. A subframe may refer to a duration of 1 ms. Multiple subframes or slots may be grouped together to form a single frame or radio frame. Within the present disclosure, a frame may refer to a predetermined duration (e.g., 10 ms) for wireless transmissions, with each frame consisting of, for example, 10 subframes of 1 ms each. Of course, these definitions are not required, and any suitable scheme for organizing waveforms may be utilized, and various time divisions of the waveform may have any suitable duration.

In general, base stations 108 may include a backhaul interface for communication with a backhaul portion 120 of the wireless communication system 100. The backhaul portion 120 may provide a link between a base station 108 and the core network 102. Further, in some examples, a backhaul network may provide interconnection between the respective base stations 108. Various types of backhaul interfaces may be employed, such as a direct physical connection, a virtual network, or the like using any suitable transport network.

The core network 102 may be a part of the wireless communication system 100 and may be independent of the radio access technology used in the RAN 104. In some examples, the core network 102 may be configured according to 5G standards (e.g., 5G core (5GC)). In other examples, the core network 102 may be configured according to a 4G evolved packet core (EPC), or any other suitable standard or configuration.

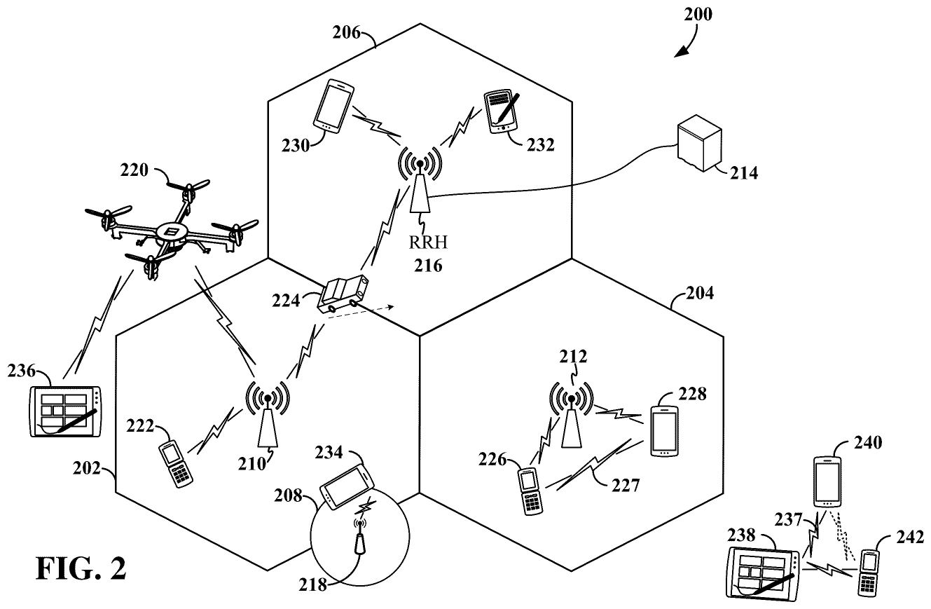

Referring now to FIG. 2, as an illustrative example without limitation, a schematic illustration of a radio access network (RAN) 200 according to some aspects of the present disclosure is provided. In some examples, the RAN 200 may be the same as the RAN 104 described above and illustrated in FIG. 1.

The geographic region covered by the RAN 200 may be divided into a number of cellular regions (cells) that can be uniquely identified by a user equipment (UE) based on an identification broadcasted over a geographical area from one access point or base station. FIG. 2 illustrates cells 202, 204, 206, and 208, each of which may include one or more sectors (not shown). A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

Various base station arrangements can be utilized. For example, in FIG. 2, two base stations, base station 210 and base station 212 are shown in cells 202 and 204. A third base station, base station 214 is shown controlling a remote radio head (RRH) 216 in cell 206. That is, a base station can have an integrated antenna or can be connected to an antenna or RRH 216 by feeder cables. In the illustrated example, cells 202, 204, and 206 may be referred to as macrocells, as the base stations 210, 212, and 214 support cells having a large size. Further, a base station 218 is shown in the cell 208, which may overlap with one or more macrocells. In this example, the cell 208 may be referred to as a small cell (e.g., a small cell, a microcell, picocell, femtocell, home base station, home Node B, home eNode B, etc.), as the base station 218 supports a cell having a relatively small size. Cell sizing can be done according to system design as well as component constraints.

It is to be understood that the RAN 200 may include any number of wireless base stations and cells. Further, a relay node may be deployed to extend the size or coverage area of a given cell. The base stations 210, 212, 214, 218 provide wireless access points to a core network for any number of mobile apparatuses. In some examples, the base stations 210, 212, 214, and/or 218 may be the same as or similar to the scheduling entity 108 described above and illustrated in FIG. 1.

FIG. 2 further includes an unmanned aerial vehicle (UAV) 220, which may be a drone or quadcopter. The UAV 220 may be configured to function as a base station, or more specifically as a mobile base station. That is, in some examples, a cell may not necessarily be stationary, and the geographic area of the cell may move according to the location of a mobile base station, such as the UAV 220.

Within the RAN 200, the cells may include UEs that may be in communication with one or more sectors of each cell. Further, each base station 210, 212, 214, 218, and 220 may be configured to provide an access point to a core network 102 (see FIG. 1) for all the UEs in the respective cells. For example, UEs 222 and 224 may be in communication with base station 210; UEs 226 and 228 may be in communication with base station 212; UEs 230 and 232 may be in communication with base station 214 by way of RRH 216; UE 234 may be in communication with base station 218; and UE 236 may be in communication with mobile base station 220. In some examples, the UEs 222, 224, 226, 228, 230, 232, 234, 236, 238, 240, and/or 242 may be the same as or similar to the UE/scheduled entity 106 described above and illustrated in FIG. 1. In some examples, the UAV 220 (e.g., the quadcopter) can be a mobile network node and may be configured to function as a UE. For example, the UAV 220 may operate within cell 202 by communicating with base station 210.

In a further aspect of the RAN 200, sidelink signals may be used between UEs without necessarily relying on scheduling or control information from a base station. Sidelink communication may be utilized, for example, in a device-to-device (D2D) network, peer-to-peer (P2P) network, vehicle-to-vehicle (V2V) network, vehicle-to-everything (V2X) network, and/or other suitable sidelink network. For example, two or more UEs (e.g., UEs 238, 240, and 242) may communicate with each other using sidelink signals 237 without relaying that communication through a base station. In some examples, the UEs 238, 240, and 242 may each function as a scheduling entity or transmitting sidelink device and/or a scheduled entity or a receiving sidelink device to schedule resources and communicate sidelink signals 237 therebetween without relying on scheduling or control information from a base station. In other examples, two or more UEs (e.g., UEs 226 and 228) within the coverage area of a base station (e.g., base station 212) may also communicate sidelink signals 227 over a direct link (sidelink) without conveying that communication through the base station 212. In this example, the base station 212 may allocate resources to the UEs 226 and 228 for the sidelink communication.

In order for transmissions over the air interface to obtain a low block error rate (BLER) while still achieving very high data rates, channel coding may be used. That is, wireless communication may generally utilize a suitable error correcting block code. In a typical block code, an information message or sequence is split up into code blocks (CBs), and an encoder (e.g., a CODEC) at the transmitting device then mathematically adds redundancy to the information message. Exploitation of this redundancy in the encoded information message can improve the reliability of the message, enabling correction for any bit errors that may occur due to the noise.

Data coding may be implemented in multiple manners. In early 5G NR specifications, user data is coded using quasi-cyclic low-density parity check (LDPC) with two different base graphs: one base graph is used for large code blocks and/or high code rates, while the other base graph is used otherwise. Control information and the physical broadcast channel (PBCH) are coded using Polar coding, based on nested sequences. For these channels, puncturing, shortening, and repetition are used for rate matching.

Aspects of the present disclosure may be implemented utilizing any suitable channel code. Various implementations of base stations and UEs may include suitable hardware and capabilities (e.g., an encoder, a decoder, and/or a CODEC) to utilize one or more of these channel codes for wireless communication.

In the RAN 200, the ability of UEs to communicate while moving, independent of their location, is referred to as mobility. The various physical channels between the UE and the RAN 200 are generally set up, maintained, and released under the control of an access and mobility management function (AMF). In some scenarios, the AMF may include a security context management function (SCMF) and a security anchor function (SEAF) that performs authentication. The SCMF can manage, in whole or in part, the security context for both the control plane and the user plane functionality.

In various aspects of the disclosure, the RAN 200 may utilize DL-based mobility or UL-based mobility to enable mobility and handovers (i.e., the transfer of a UE's connection from one radio channel to another). In a network configured for DL-based mobility, during a call with a scheduling entity, or at any other time, a UE may monitor various parameters of the signal from its serving cell as well as various parameters of neighboring cells. Depending on the quality of these parameters, the UE may maintain communication with one or more of the neighboring cells. During this time, if the UE moves from one cell to another, or if signal quality from a neighboring cell exceeds that from the serving cell for a given amount of time, the UE may undertake a handoff or handover from the serving cell to the neighboring (target) cell. For example, the UE 224 may move from the geographic area corresponding to its serving cell 202 to the geographic area corresponding to a neighbor cell 206. When the signal strength or quality from the neighbor cell 206 exceeds that of its serving cell 202 for a given amount of time, the UE 224 may transmit a reporting message to its serving base station 210 indicating this condition. In response, the UE 224 may receive a handover command, and the UE may undergo a handover to the cell 206.

In a network configured for UL-based mobility, UL reference signals from each UE may be utilized by the network to select a serving cell for each UE. In some examples, the base stations 210, 212, and 214/216 may broadcast unified synchronization signals (e.g., unified Primary Synchronization Signals (PSSs), unified Secondary Synchronization Signals (SSSs) and unified Physical Broadcast Channels (PBCHs)). The UEs 222, 224, 226, 228, 230, and 232 may receive the unified synchronization signals, derive the carrier frequency, and slot timing from the synchronization signals, and in response to deriving timing, transmit an uplink pilot or reference signal. The uplink pilot signal transmitted by a UE (e.g., UE 224) may be concurrently received by two or more cells (e.g., base stations 210 and 214/216) within the RAN 200. Each of the cells may measure a strength of the pilot signal, and the radio access network (e.g., one or more of the base stations 210 and 214/216 and/or a central node within the core network) may determine a serving cell for the UE 224. As the UE 224 moves through the RAN 200, the RAN 200 may continue to monitor the uplink pilot signal transmitted by the UE 224. When the signal strength or quality of the pilot signal measured by a neighboring cell exceeds that of the signal strength or quality measured by the serving cell, the RAN 200 may handover the UE 224 from the serving cell to the neighboring cell, with or without informing the UE 224.

Although the synchronization signal transmitted by the base stations 210, 212, and 214/216 may be unified, the synchronization signal may not identify a particular cell, but rather may identify a zone of multiple cells operating on the same frequency and/or with the same timing. The use of zones in 5G networks or other next generation communication networks enables the uplink-based mobility framework and improves the efficiency of both the UE and the network, since the number of mobility messages that need to be exchanged between the UE and the network may be reduced.

In various implementations, the air interface in the radio access network 200 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without need for a government-granted license. While compliance with some technical rules is generally still required to access unlicensed spectrum, generally, any operator or device may gain access. Shared spectrum may fall between licensed and unlicensed spectrum, wherein technical rules or limitations may be required to access the spectrum, but the spectrum may still be shared by multiple operators and/or multiple RATs. For example, the holder of a license for a portion of licensed spectrum may provide licensed shared access (LSA) to share that spectrum with other parties, e.g., with suitable licensee-determined conditions to gain access.

The electromagnetic spectrum is often subdivided, based on frequency/wavelength, into various classes, bands, channels, etc. In 5G NR two initial operating bands have been identified as frequency range designations FR1 (410 MHz-7.125 GHZ) and FR2 (24.25 GHz-52.6 GHZ). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into the mid-band frequencies. In addition, higher frequency bands are currently being explored to extend 5G NR operation beyond 52.6 GHz. For example, three higher operating bands have been identified as frequency range designations FR4-a or FR4-1 (52.6 GHZ-71 GHZ), FR4 (52.6 GHZ-114.25 GHZ), and FR5 (114.25 GHZ-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

Devices communicating in the radio access network 200 may utilize one or more multiplexing techniques and multiple access algorithms to enable simultaneous communication of the various devices. For example, 5G NR specifications provide multiple access for UL transmissions from UEs 222 and 224 to base station 210, and for multiplexing for DL transmissions from base station 210 to one or more UEs 222 and 224, utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the base station 210 to UEs 222 and 224 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

Devices in the radio access network 200 may also utilize one or more duplexing algorithms. Duplex refers to a point-to-point communication link where both endpoints can communicate with one another in both directions. Full-duplex means both endpoints can simultaneously communicate with one another. Half-duplex means only one endpoint can send information to the other at a time. Half-duplex emulation is frequently implemented for wireless links utilizing time division duplex (TDD). In TDD, transmissions in different directions on a given channel are separated from one another using time division multiplexing. That is, in some scenarios, a channel is dedicated for transmissions in one direction, while at other times the channel is dedicated for transmissions in the other direction, where the direction may change very rapidly, e.g., several times per slot. In a wireless link, a full-duplex channel generally relies on physical isolation of a transmitter and receiver, and suitable interference cancellation technologies. Full-duplex emulation is frequently implemented for wireless links by utilizing frequency division duplex (FDD) or spatial division duplex (SDD). In FDD, transmissions in different directions may operate at different carrier frequencies (e.g., within paired spectrum). In SDD, transmissions in different directions on a given channel are separated from one another using spatial division multiplexing (SDM). In other examples, full-duplex communication may be implemented within unpaired spectrum (e.g., within a single carrier bandwidth), where transmissions in different directions occur within different sub-bands of the carrier bandwidth. This type of full-duplex communication may be referred to herein as sub-band full-duplex (SBFD), also known as flexible duplex.

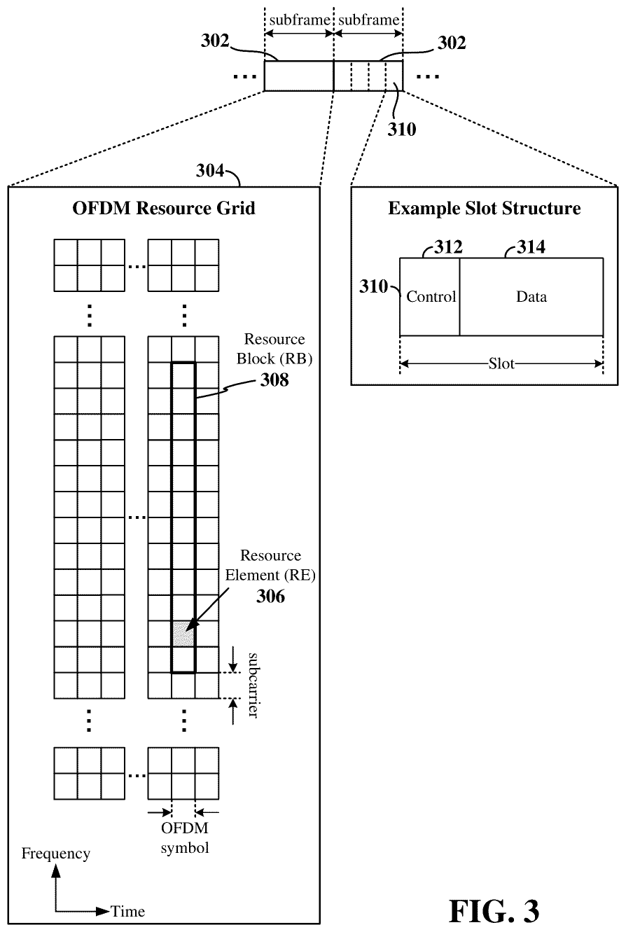

Various aspects of the present disclosure will be described with reference to an OFDM waveform, schematically illustrated in FIG. 3. It should be understood by those of ordinary skill in the art that the various aspects of the present disclosure may be applied to an SC-FDMA waveform in substantially the same way as described hereinbelow. That is, while some examples of the present disclosure may focus on an OFDM link for clarity, it should be understood that the same principles may be applied as well to SC-FDMA waveforms.

Referring now to FIG. 3, an expanded view of an exemplary subframe 302 is illustrated, showing an OFDM resource grid according to some aspects of the disclosure. However, as those skilled in the art will readily appreciate, the physical (PHY) transmission structure for any particular application may vary from the example described herec, depending on any number of factors. Here, time is in the horizontal direction with units of OFDM symbols; and frequency is in the vertical direction with units of subcarriers of the carrier.

The resource grid 304 may be used to schematically represent time-frequency resources for a given antenna port. That is, in a multiple-input-multiple-output (MIMO) implementation with multiple antenna ports available, a corresponding multiple number of resource grids 304 may be available for communication. The resource grid 304 is divided into multiple resource elements (REs) 306. An RE, which is 1 subcarrier×1 symbol, is the smallest discrete part of the time-frequency grid, and contains a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 308, which contains any suitable number of consecutive subcarriers in the frequency domain. In one example, an RB may include 12 subcarriers, a number independent of the numerology used. In some examples, depending on the numerology, an RB may include any suitable number of consecutive OFDM symbols in the time domain. Within the present disclosure, it is assumed that a single RB such as the RB 308 entirely corresponds to a single direction of communication (either transmission or reception for a given device).

A set of continuous or discontinuous resource blocks may be referred to herein as a Resource Block Group (RBG), sub-band, or bandwidth part (BWP). A set of sub-bands or BWPs may span the entire bandwidth. Scheduling of scheduled entities (e.g., UEs) for downlink, uplink, or sidelink transmissions typically involves scheduling one or more resource elements 306 within one or more sub-bands or bandwidth parts (BWPs). Thus, a UE generally utilizes only a subset of the resource grid 304. In some examples, an RB may be the smallest unit of resources that can be allocated to a UE. Thus, the more RBs scheduled for a UE, and the higher the modulation scheme chosen for the air interface, the higher the data rate for the UE. The RBs may be scheduled by a scheduling entity, such as a base station (e.g., gNB, eNB, etc.), or may be self-scheduled by a UE implementing D2D sidelink communication.

In this illustration, the RB 308 is shown as occupying less than the entire bandwidth of the subframe 302, with some subcarriers illustrated above and below the RB 308. In a given implementation, the subframe 302 may have a bandwidth corresponding to any number of one or more RBs 308. Further, in this illustration, the RB 308 is shown as occupying less than the entire duration of the subframe 302, although this is merely one possible example.

Each 1 ms subframe 302 may consist of one or multiple adjacent slots. In the example shown in FIG. 3, one subframe 302 includes four slots 310, as an illustrative example. In some examples, a slot may be defined according to a specified number of OFDM symbols with a given cyclic prefix (CP) length. For example, a slot may include 7 or 14 OFDM symbols with a nominal CP. Additional examples may include mini-slots, sometimes referred to as shortened transmission time intervals (TTIs), having a shorter duration (e.g., one to three OFDM symbols). These mini-slots or shortened transmission time intervals (TTIs) may in some cases be transmitted occupying resources scheduled for ongoing slot transmissions for the same or for different UEs. Any number of resource blocks may be utilized within a subframe or slot.

An expanded view of one of the slots 310 illustrates the slot 310 including a control region 312 and a data region 314. In general, the control region 312 may carry control channels, and the data region 314 may carry data channels. Of course, a slot may contain all DL, all UL, or at least one DL portion and at least one UL portion. The structure illustrated in FIG. 3 is merely exemplary in nature, and different slot structures may be utilized, and may include one or more of each of the control region(s) and data region(s).

Although not illustrated in FIG. 3, the various REs 306 within a RB 308 may be scheduled to carry one or more physical channels, including control channels, shared channels, data channels, etc. Other REs 306 within the RB 308 may also carry pilots or reference signals. These pilots or reference signals may provide for a receiving device to perform channel estimation of the corresponding channel, which may enable coherent demodulation/detection of the control and/or data channels within the RB 308.

In some examples, the slot 310 may be utilized for broadcast, multicast, groupcast, or unicast communication. For example, a broadcast, multicast, or groupcast communication may refer to a point-to-multipoint transmission by one device (e.g., a base station, UE, or other similar device) to other devices. Here, a broadcast communication is delivered to all devices, whereas a multicast or groupcast communication is delivered to multiple intended recipient devices. A unicast communication may refer to a point-to-point transmission by one device to a single other device.

In an example of cellular communication over a cellular carrier via a Uu interface, for a DL transmission, the scheduling entity (e.g., a base station) may allocate one or more REs 306 (e.g., within the control region 312) to carry DL control information including one or more DL control channels, such as a physical downlink control channel (PDCCH), to one or more scheduled entities (e.g., UEs). The PDCCH carries downlink control information (DCI) including but not limited to power control commands (e.g., one or more open loop power control parameters and/or one or more closed loop power control parameters), scheduling information, a grant, and/or an assignment of REs for DL and UL transmissions. The PDCCH may further carry hybrid automatic repeat request (HARQ) feedback transmissions such as an acknowledgment (ACK) or negative acknowledgment (NACK). HARQ is a technique well-known to those of ordinary skill in the art, wherein the integrity of packet transmissions may be checked at the receiving side for accuracy, e.g., utilizing any suitable integrity checking mechanism, such as a checksum or a cyclic redundancy check (CRC). If the integrity of the transmission is confirmed, an ACK may be transmitted, whereas if not confirmed, a NACK may be transmitted. In response to a NACK, the transmitting device may send a HARQ retransmission, which may implement chase combining, incremental redundancy, etc.

The base station may further allocate one or more REs 306 (e.g., in the control region 312 or the data region 314) to carry other DL signals, such as a demodulation reference signal (DMRS); a phase-tracking reference signal (PT-RS); a channel state information (CSI) reference signal (CSI-RS); and a synchronization signal block (SSB). SSBs may be broadcast at regular intervals based on a periodicity (e.g., 5, 10, 20, 40, 80, or 160 ms). An SSB includes a primary synchronization signal (PSS), a secondary synchronization signal (SSS), and a physical broadcast control channel (PBCH). A UE may utilize the PSS and SSS to achieve radio frame, subframe, slot, and symbol synchronization in the time domain, identify the center of the channel (system) bandwidth in the frequency domain, and identify the physical cell identity (PCI) of the cell.

The PBCH in the SSB may further include a master information block (MIB) that includes various system information, along with parameters for decoding a system information block (SIB). The SIB may be, for example, a SystemInformationType 1 (SIB1) that may include various additional system information. The MIB and SIB1 together provide the minimum system information (SI) for initial access. Examples of system information transmitted in the MIB may include, but are not limited to, a subcarrier spacing (e.g., default downlink numerology), system frame number, a configuration of a PDCCH control resource set (CORESET) (e.g., PDCCH CORESET0), a cell barred indicator, a cell reselection indicator, a raster offset, and a search space for SIB1. Examples of remaining minimum system information (RMSI) transmitted in the SIB1 may include, but are not limited to, a random access search space, a paging search space, downlink configuration information, and uplink configuration information. A base station may transmit other system information (OSI) as well.

In an UL transmission, the scheduled entity (e.g., UE) may utilize one or more REs 306 to carry UL control information (UCI) including one or more UL control channels, such as a physical uplink control channel (PUCCH), to the scheduling entity. UCI may include a variety of packet types and categories, including pilots, reference signals, and information configured to enable or assist in decoding uplink data transmissions. Examples of uplink reference signals may include a sounding reference signal (SRS) and an uplink DMRS. In some examples, the UCI may include a scheduling request (SR), i.e., request for the scheduling entity to schedule uplink transmissions. Here, in response to the SR transmitted on the UCI, the scheduling entity may transmit downlink control information (DCI) that may schedule resources for uplink packet transmissions. UCI may also include HARQ feedback, channel state feedback (CSF), such as a CSI report, or any other suitable UCI.

In addition to control information, one or more REs 306 (e.g., within the data region 314) may be allocated for data. Such data may be carried on one or more traffic channels, such as, for a DL transmission, a physical downlink shared channel (PDSCH); or for an UL transmission, a physical uplink shared channel (PUSCH). In some examples, one or more REs 306 within the data region 314 may be configured to carry other signals, such as one or more SIBs and DMRSs. In some examples, the PDSCH may carry a plurality of SIBs, not limited to SIB1, discussed above. For example, the OSI may be provided in these SIBs, e.g., SIB2 and above.

In an example of sidelink communication over a sidelink carrier via a proximity service (ProSc) PC5 interface, the control region 312 of the slot 310 may include a physical sidelink control channel (PSCCH) including sidelink control information (SCI) transmitted by an initiating (transmitting) sidelink device (e.g., Tx V2X device or other Tx UE) towards a set of one or more other receiving sidelink devices (e.g., Rx V2X device or other Rx UE). The data region 314 of the slot 310 may include a physical sidelink shared channel (PSSCH) including sidelink data transmitted by the initiating (transmitting) sidelink device within resources reserved over the sidelink carrier by the transmitting sidelink device via the SCI. Other information may further be transmitted over various REs 306 within slot 310. For example, HARQ feedback information may be transmitted in a physical sidelink feedback channel (PSFCH) within the slot 310 from the receiving sidelink device to the transmitting sidelink device. In addition, one or more reference signals, such as a sidelink SSB, a sidelink CSI-RS, a sidelink SRS, and/or a sidelink positioning reference signal (PRS) may be transmitted within the slot 310.

These physical channels described above are generally multiplexed and mapped to transport channels for handling at the medium access control (MAC) layer. Transport channels carry blocks of information called transport blocks (TB). The transport block size (TBS), which may correspond to a number of bits of information, may be a controlled parameter, based on the modulation and coding scheme (MCS) and the number of RBs in a given transmission.

The channels or carriers illustrated in FIGS. 1, 2, and 3 are not necessarily all of the channels or carriers that may be utilized between devices, and those of ordinary skill in the art will recognize that other channels or carriers may be utilized in addition to those illustrated, such as other traffic, control, and feedback channels.

### Additive White Gaussian Noise and the Shaping Gap

In current wireless communication systems, higher-order modulation schemes (e.g., 16QAM, 64QAM and 256QAM) are used. The constellations in these wireless communication systems are fixed and each constellation point is used with equal probability. Channels may be estimated or modeled using a concept referred to as additive white Gaussian noise (AWGN). An AWGN channel adds white Gaussian noise to a signal that passes through the channel. Signals transmitted according to all modulation schemes (e.g., QAM schemes and/or BPSK schemes) over an AWGN channel may seek to maximize their respective channel capacities. Generally, a maximized channel capacity is achievable if the input signal distribution is a Gaussian distribution.

The difference between the signal-to-noise (SNR) to achieve a transmission rate with a given coding and modulation scheme and the SNR at which an optimal channel capacity-achieving modulation scheme could operate at the same transmission rate is referred to as the shaping gap. For the AWGN channel, the shaping gap can be asymptotically equal to about 1.53 dB when the channel inputs are uniformly distributed. For example, when a uniform distribution is induced over an amplitude-shift keying (ASK) constellation of points (e.g., 64ASK), the shaping gap is about 1.44 dB when the transmission rate is targeted at 5 bits per channel use.

### Types of Shaping

Existing techniques to shape the constellations of various modulation schemes (e.g., of 16QAM, 64QAM, and 256QAM schemes) and to reduce or close the shaping gap include geometric shaping and probabilistic shaping. Geometric shaping implements equiprobable signaling with Gaussian-like distributed constellation points. Probabilistic shaping employs equidistant constellation points and implements non-uniform (e.g., Gaussian-like) signal distribution.

### Probablistic Shaping

Traditional approaches to probabilistic shaping include trellis shaping and shell mapping. Probabilistic amplitude shaping (PAS) is another technique that may be used to perform probabilistic shaping. A PAS system may combine an outer layer of constellation shaping with an inner layer of binary forward-error-correction (FEC) so that the PAS system can provide low-complexity and integration flexibility with existing bit-interleaved coded modulation (BICM) schemes. A PAS system may employ ASK constellations and may extend to quadrature amplitude modulation (QAM) constellations by mapping two ASK symbols to one QAM symbol. A PAS system may provide large shaping gain and inherent rate adaptation functionality.

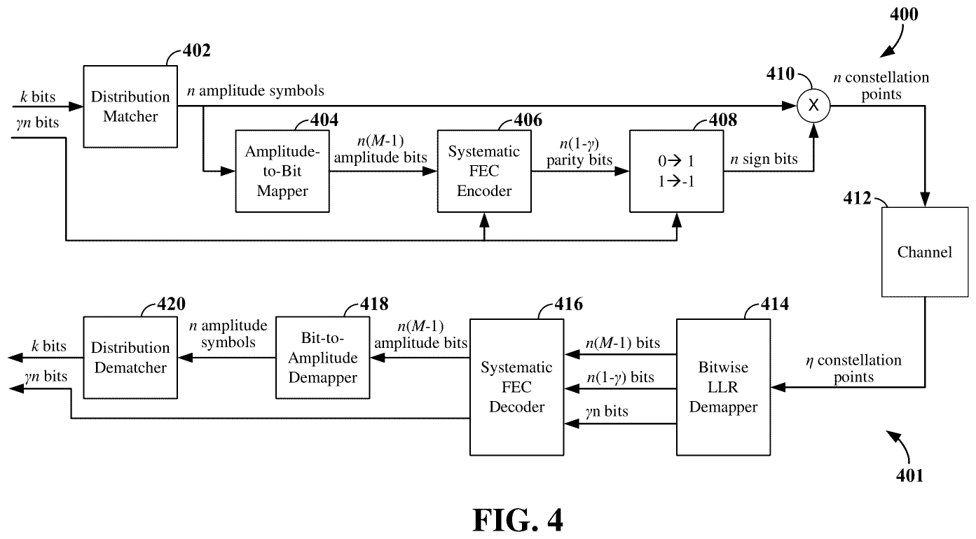

FIG. 4 is a block diagram illustrating one example of a transmitter chain 400 and a receiver chain 401 of a wireless communication device having a PAS architecture according to some aspects of the disclosure. The transmitter chain 400 receives k bits of a bit sequence and γn information bits. The k bits are applied to a distribution matcher 402. The distribution matcher 402 receives the k bits and outputs n amplitude symbols. The n amplitude symbols are provided to two devices/functions; namely, an amplitude-to-bit mapper 404 and a mixer 410. The amplitude-to-bit mapper 404 converts the n amplitude symbols into n(M−1) amplitude bits, which are applied to a systematic FEC encoder 406. Here, 2^{M} may be referred to as a modulation order of an underlying 2^{M}-ary ASK alphabet. The systematic FEC encoder receives the n(M−1) amplitude bits and outputs n(1−γ) parity bits. The n(1−γ) parity bits are applied to a sign mapping 408 device/function, which provides n sign bits (e.g., 1 or −1) to the mixer 410. The mixer 410 mixes the n amplitude symbols with the n sign bits and outputs n constellation points. The n constellation points are passed through a radio channel 412 toward the receiver chain 401. The n constellation points are received by a bitwise log-likelihood ratio (LLR) demapper 414 of the receiver chain 401, which provides three outputs; namely, n(M−1) amplitude bits, n(1−γ) parity bits, and γn information bits. The n(M−1) amplitude bits, n(1-γ) parity bits, and γn information bits are received by a systematic FEC decoder 416, which outputs the n(M−1) amplitude bits to a bit-to-amplitude demapper 418. The bit-to-amplitude demapper 418 receives the n(M−1) amplitude bits and outputs n amplitude symbols. The n amplitude symbols are applied to a distribution dematcher 420, which outputs the k bits of a bit sequence. The k bits of a bit sequence from the distribution dematcher 420 and the γn information bits from the systematic FEC decoder 416 may be output from the receiver chain 401 for further processing.

### Terminologies

In general, a 2^{M}-ary ASK constellation may be formed of the following set of values: {±1, ±3, . . . , ±(2^{M}−1)} with an amplitude alphabet [symbol] ={1, 3, . . . , (2^{M}−1)}.

A distribution matching rate (R_{dm}) may be given as:

$${R}_{d m} = \frac{k}{n} \qquad ( 1 )$$

where k is a bit sequence length and n is an amplitude symbol sequence length.

A systematic forward-error-correction (FEC) code rate (R_{c}) may be given as:

$${R}_{c} = \frac{M - 1 + γ}{M} . \qquad ( 2 )$$

The n(M−1) amplitude bits and the γn information bits together constitute the n(M−1+γ) bits as input to a systematic FEC encoder, such as the systematic FEC encoder 406 as shown and described above in connection with FIG. 4. Also as shown and described above in connection with FIG. 4, the systematic FEC encoder may generate n(1−γ) parity bits. These n(1−γ) parity bits together with the γn information bits may be converted to n sign bits and are pointwise multiplied with the n amplitude symbol sequence from the output of the distribution matcher.

A transmission rate (Rₜ) may be given as:

$${R}_{t} = {R}_{d m} + γ . \qquad ( 3 )$$

### Distribution Matching

A fixed-to-fixed (e.g., one-to-one) distribution matching (DM) maps a length-k bit sequence to a length-n amplitude symbol sequence. The distribution matcher 402, as shown and described above in connection with FIG. 4, may perform distribution matching according to some aspects described herein. Distribution matching may induce a non-uniform marginal distribution over the amplitude symbols (e.g., {1, 3, . . . , (2^{M}−1)}) of the n amplitude symbol sequence.

Here k and n are non-zero positive integer values. The bits of the length-k bit sequence may be independent and may be identically distributed with a uniform distribution. The symbols of the n amplitude symbol sequence may have a non-uniform distribution. The non-uniform distribution over the symbols of the n amplitude symbol sequence may be induced by distribution matching and may be expected to be closer to a maximum capacity-achieving distribution than would be achieved had a uniform distribution over the symbols of the n amplitude symbol sequence been utilized. In other words, the non-uniform distribution induced by the distribution matching may be more Gaussian-like or more like a Maxwell-Boltzmann distribution in an AWGN setting.

Regarding the Maxwell-Boltzmann distribution and shaping gain, the Maxwell-Boltzmann distribution for ASK constellations may be given as a symmetric probability distribution of the form:

$${p}_{v} ( x ) = \frac{1}{{Z}_{v}} {e}^{- v {x}^{2}} \qquad ( 4 )$$

where x∈{±1, ±3, . . . , ±(2^{M}−1)}. Note that this symmetric probability distribution induces a Maxwell-Boltzmann distribution for amplitudes.

### Shaping Gain Over an Additive White Gaussian Noise Channel

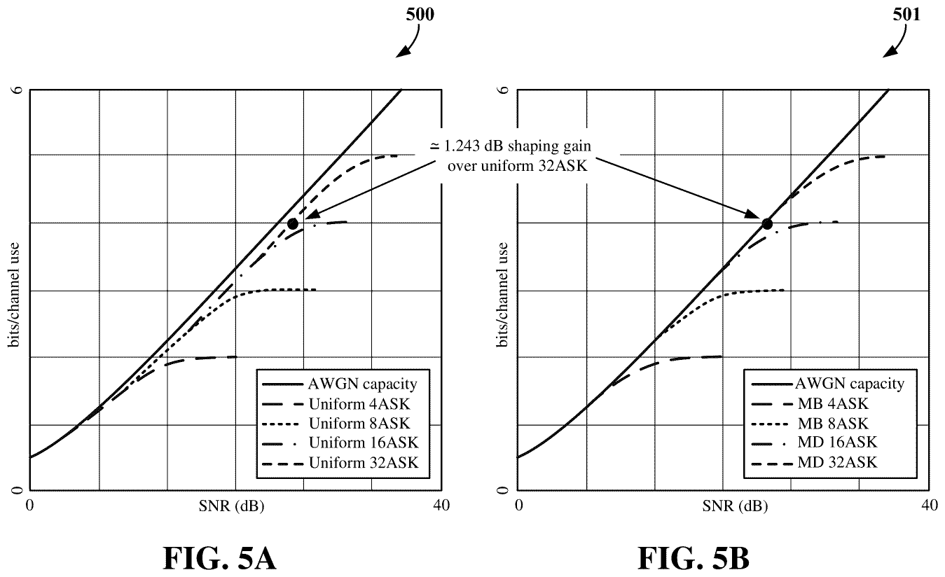

FIGS. 5A and 5B illustrate the concept of shaping gain over an AWGN channel. Both FIGS. 5A and 5B illustrate signal-to-noise ratio (SNR) versus bits per channel use. In both figures, SNR is on the horizontal axis with units of dB and bits/channel use is on the vertical axis with units of bits. In this example, the bits/channel use range from 0 to 6 bits. FIG. 5A is a first plot 500 of SNR as a function of uniformly distributed ASK constellations according to some aspects of the disclosure. FIG. 5B is a second plot 501 of SNR as a function of optimal Maxwell-Boltzmann distributed constellations according to some aspects of the disclosure. In both figures, performance for 4, 8, 16, and 32ASK constellations are depicted. The 4ASK traces are the bottommost curved traces and the 32ASK traces are the topmost curved traces. In both graphs, ideal AWGN capacity is depicted as the topmost line.

For illustration and not limitation, marks are placed at 4 bits/channel use on the 32ASK traces. As shown, the Maxwell-Boltzmann distributed 32ASK input exhibits a shaping gain of about 1.243 dB over the uniformly distributed 32ASK input.

### Sphere Shaping

In addition to geometric shaping and probabilistic shaping, another type of shaping is known as sphere shaping. In the context of ASK constellations, sphere shaping considers 2^{k} symbol sequences of length n with minimal energy. The mapping from length-k bit sequences to length-n amplitude symbol sequences is one-to-one. Table 1, below, illustrates the one-to-one mapping of the length-k bit sequences to the length-n amplitude symbol sequences for symbol energy values of 5, 13, and 21 (where symbol energy decreases as the symbol energy value increases). Table 1 is provided for illustration and not limitation.

TABLE 1

| Bit | Amplitude Symbol | Symbol Energy |
|---|---|---|
| Sequence | Sequence | (in descending order) |
| (0, 0, 0, 0) | (1, 1, 1, 1, 1) | 5 |
| (0, 0, 1, 0) | (1, 1, 1, 1, 3) | |
| (0, 0, 1, 0) | (1, 1, 1, 3, 1) | |
| (0, 0, 1, 1) | (1, 1, 3, 1, 1) | 13 |
| (01, 0, 0) | (1, 3, 1, 1, 1) | |
| (0, 1, 0, 1) | (3, 1, 1, 1, 1) | |
| (0, 1, 1, 0) | (1, 1, 1, 3, 3) | |
| (0, 1, 1, 1) | (1, 1, 3, 1, 3) | |
| (1, 0, 0, 0) | (1, 1, 3, 3, 1) | |
| (1, 0, 0, 1) | (1, 3, 1, 1, 3) | |
| (1, 0, 1, 0) | (1, 3, 1, 3, 1) | 21 |
| (1, 0, 1, 1) | (1, 3, 3, 1, 1) | |
| (1, 1, 0, 0) | (3, 1, 1, 1, 3) | |
| (1, 1, 0, 1) | (3, 1, 1, 3, 1) | |
| (1, 1, 1, 0) | (3, 1, 3, 1, 1) | |
| (1, 1, 1, 1) | (3, 3, 1, 1, 1) | |

As depicted in Table 1, sphere shaping uses minimum energy sequences. Additionally, the marginal distribution obtained using sphere shaping is close to a Maxwell-Boltzmann distribution. Furthermore, sphere shaping has near optimal shaping gain and minimum energy use for a given rate. However, processes used to implement sphere shaping may have high computational complexity and/or may require large storage capacity (e.g., compared to processes used to implement geometric shaping and/or probabilistic shaping). At least one reason for the high computational complexity and/or large storage capacity may be because sphere shaping processes may be polynomial in the sequence length n (e.g., such a process is not linear in the sequence length n).

### Symbol Energy

Table 1 introduces the concept of symbol energy. Symbol energy may be discussed in connection with a given alphabet. With regard to the given alphabet, [symbol] , let m>1 be an integer and let [symbol] ={a₁, a₂, . . . , aₘ} be a symbol alphabet of size m. An ordering may be imposed on the symbol alphabet [symbol] such that aᵢ<aᵢ₊₁ for each i, i.e., a₁<a₂< . . . <aₘ.

Regarding the energy of a symbol in connection with the given symbol alphabet [symbol] ={a₁, a₂, . . . , aₘ} of size m, we may denote by E(aᵢ) the energy of symbol aᵢ for each i. In connection with aspects described herein, it may be assumed that symbol energies are distinct and further assumed that for any i∈{1, 2, . . . , m−1} that 0≤∈(aᵢ)<E(aᵢ₊₁). As used herein, the symbol “∈” means “an element of.”

Examples of symbol energy are given below for illustrative and non-limiting purposes. The examples consider amplitude-shift keying (ASK) constellation cases. In such cases, we take the symbol alphabet [symbol] ={1, 3, . . . , 2^{M}−1} so that m=2^{M}−1 and {−1, 1}× [symbol] corresponds to a 2^{M}-ary ASK alphabet (this means that m depends on a modulation order). In this case, aᵢ=2i−1 so that a₁=1, a₂=3, . . . , aₘ=2^{M}−1.
Symbol Energy Example 1: for each i, let:

$$E ( {a}_{i} ) = {( 2 i - 1 )}^{2} .$$

Symbol Energy Example 2: for each i, let:

$$E ( {a}_{i} ) = \frac{i ( i - 1 )}{2} .$$

Because 8E(aᵢ)+1=(2i−1)², evaluating E(aᵢ) only involves a rescaling of (2i−1)². For example, the equation 8E(aᵢ)+1=(2i−1)² indicates a relationship between (2i−1)² in Example 1 and E(aᵢ) when E(aᵢ) is defined using i(i−1)/2 as in Example 2. More precisely, 8i(i−1)/2+1=4i²−4i+1=(2i−1)².

### Energy of a Sequence

The concept of energy of a sequence may also be considered herein. Specifically, given a symbol alphabet [symbol] of size m, consider a sequence s=(s₁, s₂, . . . , sₙ), each element of which takes values in [symbol] . The energy of the sequence s, denoted by E(s), may be defined as an accumulation (i.e., a summation) of all symbol energies. This may be expressed mathematically as:

$$E ( s ) = {\sum }_{l = 1}^{n} E ( {s}_{l} ) . \qquad ( 5 )$$

Next, denote by

$${s}_{1}^{t}$$

the prefix (s₁, s₂, . . . , sₜ) of s so that the sequence s is also denoted by

$${s}_{1}^{n}$$

The energy of the prefix

$${s}_{1}^{t}$$

may be given as:

$$E ( {s}_{1}^{t} ) = {\sum }_{l = 1}^{t} E ( {s}_{l} ) . \qquad ( 6 )$$

### Total Number of Symbol Sequences

In the discussion that follows, the concept of a total number of symbol sequences over an alphabet, [symbol] , having length n and energy E may be utilized. The total number of symbol sequences over [symbol] having length n and energy E may be denoted herein as:

$${N}^{[ m ]} ( n , E ) . \qquad ( 7 )$$

In other words, if we denote by

$$\{ s = ( {s}_{1} , {s}_{2} , … , {s}_{n} ) \vert {s}_{i} ∈ {A}_{m} , ∀ i , E ( s ) = E \} \qquad ( 8 )$$

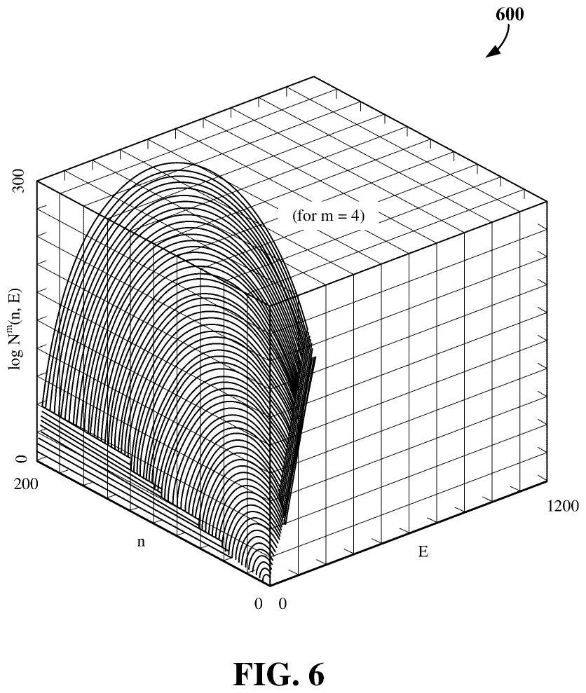

the set of all sequences over alphabet [symbol] that have a length n and an energy E, then N^{[m]}(n, E) is the cardinality of this set (i.e., N^{[m]}(n, E) is the number of elements in this set). Equation 8 may be read as: the set of s (where s=(s₁, s₂, . . . , sₙ)) such that ∀i, sᵢ is an element of: [symbol] , and E(s)=E, where sᵢ is the ith element of the set s, [symbol] is the symbol alphabet of size m, ∀i means “for all i,” E(s) is the energy of the sequence s and is equal to E. For notational ease, when the underlying size m is clear from the context, N(n, E) may be used herein as a proxy for N^{[m]}(n, E). Of course, N^{[m]}(n, E) depends on the tuple m, n, and E as depicted in FIG. 6. Here, E(s)=E may be a condition put on each sequence in the set. The contents of the set may satisfy multiple conditions, such as: 1) length must be n; 2) each element of any sequence must belong to [symbol] ; and 3) the energy of each sequence in the set must be equal to E.

FIG. 6 is a three-dimensional depiction 600 of the logarithm of N^{[m]}(n, E) (i.e., log N^{[m]}(n, E)) as a function of n and E, according to some aspects of the disclosure. In FIG. 6, m is the alphabet size and is fixed; where m=4. As used herein throughout, a logarithm may be under a proper base, such as base 2, or a natural base. It should be clear from the notation that N^{[m]}(n, E) depends on the tuple m, n, and E. The straight-forward notation, however, disguises the complexity of the concept. The complexity may be appreciated by observing the three-dimensional depiction 600 of FIG. 6, which, for example and without limitation, depicts log N^{[m]}(n, E) as a function of n and E, where m is an alphabet size and m=4.

As might be understood from the three-dimensional depiction 600 of FIG. 6, the complexity of computing and/or storing N^{[m]}(n, E) is high, in general. For example, although the computations may be straightforward, the computation of N^{[m]}(n, E) requires calculations with a complexity of a quadratic in n. Furthermore, the magnitudes of N^{[m]}(n, E) can be large. For example, the value of N^{[4]}(300, 500) is larger than 10¹⁶⁹ for an 8ASK alphabet, so that storing a table for all 10¹⁶⁹ quantities equal to and below length 300 might require more than 40 Mbytes of storage.

### Approaches to Distribution Matching Designs

Previous DM design approaches related to sphere shaping may include at least two fixed-to-fixed DM approaches. A first fixed-to-fixed DM approach may be referred to as a two-step energy-based arithmetic coding (AC) method for a fixed-to-fixed distribution matching scheme (hereinafter referred to as two-step AC-DM). A second fixed-to-fixed DM approach may be referred to as a multiple composition distribution matching based on a peeling method scheme (hereinafter referred to as three-phase peeling). These at least two fixed-to-fixed DM approaches may be used to realize sphere shaping.

### Compositions

A composition will now be described and exemplified. For a composition, given a sequence s of length n over [symbol] , the composition of s is an ordered m-tuple k(s)=(k₁(s), k₂ (s), . . . , kₘ(s)), where for each i, kᵢ(s) is the number of occurrences of aᵢ∈ [symbol] in the sequence s.

As an example, the composition of sequence s=(1, 1, 3, 1) is:

$$k ( s ) = ( 3 , 1 ) \qquad ( 9 )$$

where a composition k having energy E; may be expressed as:

$${\sum }_{i = 1}^{m} {k}_{i} ( s ) E ( {a}_{i} ) = E . \qquad ( 10 )$$

That is, the underlying sequence s has energy E.

The number of symbol sequences having composition (3, 1) is given by the multinomial coefficient:

$$N ( ( 3 , 1 ) ) {=}^{Δ} ( \{ \begin{matrix}n ( ( 3 , 1 ) ) \\ ( 3 , 1 )\end{matrix} ) = \frac{4 !}{3 ! 1 !} = 4. \qquad ( 11 )$$

The sequences over [symbol] and having composition (3, 1) are (1, 1, 1, 3), (1, 1, 3, 1), (1, 3, 1, 1) and (3, 1, 1, 1). Here, the symbol alphabet size, m, is equal to 2 because the symbol alphabet is {1, 3}. The composition is (3, 1) because, for each sequence, the number of occurrences of symbol 1 is three and the number of occurrences of symbol 3 is 1.

### The Role of N^{[m]}(n, E)

Under both fixed-to-fixed DM approaches identified above, as well as to other distribution matching methods such as, but not limited to, shell mapping, N^{[m]}(n, E) plays a fundamental role. For example, both the two-step AC-DM and three-phase peeling approaches require accessing (e.g., obtaining, determining) N^{[m]}(n, E) for a wide range of n and E as well as a set of typical values of m that may depend on the modulation order.

### Approximation of a Total Number of Symbol Sequences

As disclosed herein, the total number of symbol sequences, N^{[m]}(n, E), or some function of N^{[m]}(n, E) (e.g., log N^{[m]}(n, E)) may be approximated. An approximation of log N^{[m]}(n, E) may be represented as log Ñ^{[m]}(n, E) herein. In one example, let m≥2 and consider the number N^{[m]}(n, E) of symbol sequences of length n and energy E, each symbol belonging to [symbol] . A general form to approximate N^{[m]}(n, E) in the logarithmic domain may be given herein as:

$$log {\hat{N}}^{[ m ]} ( n , E ) = n {H}^{[ m ]} ( ω ) - \frac{1}{2} log ( 2 π {nV}^{[ m ]} ( ω ) ) + c ( E ) + {\sum }_{i = 1}^{{T}_{max}} \frac{1}{{n}^{i}} {G}_{i}^{[ m ]} ( ω ) \qquad ( 12 )$$

where:
H^{[m]}, v^{[m]} and Gᵢ^{[m]} may be respectively abbreviated as H, V and Gᵢ herein when m is clear from context;

$$ω = \frac{E}{n}$$

may be referred to as normalized energy herein;
the functions H(ω), V(ω) and Gᵢ (ω) for all i are m-dependent;
H represents an entropy function;
V represents a variance function; and
each Gᵢ represents an additional function. Here, each such Gᵢ may be referred to as an additional function because, for example, in an approximation formula such as (12), except for the terms nH^{[m]}(ω),

$$- \frac{1}{2} log ( 2 π {nV}^{[ m ]} ( ω ) ) ,$$

and c(E), the number of additional terms that the approximation formula contains depends on the parameter Tₘₐₓ. For example, if Tₘₐₓ=1 there is one additional function, G₁; if Tₘₐₓ=2 there are two additional functions, G₁ and G₂, etc.
It is noted that as used herein, the two phrases “approximate N^{[m]}(n, E) in the logarithmic domain” and “approximate log N^{[m]}(n, E)” mean the same thing.

Nevertheless, evaluations of each of the functions in equation (12) for any pair of n and E as a function of m may involve computational complexity that may be a burden to the resources of a processing circuit. For example, each evaluation may involve solving for the root λ=λ(ω) of the polynomial equation:

$$\frac{{Z}_{1} ( λ )}{{Z}_{0} ( λ )} = ω , \qquad ( 13 )$$

where the polynomials: Z₀(z) and Z₁ (z) are given by:

$${Z}_{0} ( z ) = {\sum }_{i = 1}^{m} {z}^{E ( {a}_{i} )} \qquad ( 14 )$$

$${Z}_{1} ( z ) = {\sum }_{i = 1}^{m} E ( {a}_{i} ) {z}^{E ( {a}_{i} )} . \qquad ( 15 )$$

By way of another example, each evaluation may involve taking the logarithm of a real positive number such as the log V^{[m]} term.

By way of still another example, each evaluation may involve taking powers of real numbers while the powers increase with m.

Still, it may be observed that the functions H, logV and Gᵢ are smooth functions over the interior of the interval [0, E(aₘ)]. Here, the term “smooth” refers to a relative lack of discontinuities. This smooth property may be exploited herein by recognizing that additional approximations of the functions H, logV and Gᵢ may be less computationally complex than the computations of the functions themselves.

Accordingly, aspects described herein propose to approximate the value of log N^{[m]}(n, E) by, for example, evaluating log \hat{N}^{[m]}(n, E) using approximations of H(ω), log V(ω) and Gᵢ (ω) for each i. Accordingly, the resulting approximate functions may be denoted herein as:

$$\hat{H} ( ω ) ; \qquad ( 16 )$$

$$( ω ) ; \\ and \qquad ( 17 )$$

$${\hat{G}}_{i} ( ω ) \qquad ( 18 )$$

By using the approximate values of Ĥ(ω), [symbol] (ω) and Ĝᵢ (ω), log \hat{N}^{[m]}(n, E) may be given by:

$$log {\hat{N}}^{[ m ]} ( n , E ) = n \hat{H} ( ω ) - \frac{1}{2} log n - \frac{1}{2} ( ω ) + c ( E ) + {\sum }_{i = 1}^{{T}_{m ax}} \frac{1}{{n}^{i}} {\hat{G}}_{i} ( ω ) \qquad ( 19 )$$

Here, Ĥ, [symbol] , and Ĝᵢ (as abbreviations of Ĥ^{[m]}, [symbol] ^{[m]}, and Ĝᵢ^{[m]}) may be piecewise polynomial approximations of H, logV and Gᵢ, where, as stated above, H represents an entropy function; V represents a variance function; and each Gᵢ represents an additional function.

Additionally, Tₘₐₓ may be viewed as a parameter. In some examples, a large Tₘₐₓ (e.g., Tₘₐₓ>2) may imply that more additional functions are involved in the approximation expressions in (12) or (19) (above) or (48) (below). This may increase the approximation accuracy. However, more additional functions may mean that more computations may be needed, which may lead to having more terms. According to some examples, setting Tₘₐₓ equal to 1 or 2 may render sufficiently accurate approximations. By way of example, for Tₘₐₓ=1, Gᵢ may represent one additional function (e.g., G₁), while for Tₘₐₓ>1, Gᵢ may represent more than one additional function (e.g., when Tₘₐₓ=2, there are two additional functions, G₁ and G₂). It is noted that G₁ is multiplied by 1/n and G₂ is multiplied by 1/n².

To save computational resources (e.g., computational time, processor power, etc.), the constant

$$- \frac{1}{2} log 2 π$$

in the log \hat{N}_{[m]}(n, E) equation (12) may be neglected. This conclusion may be reached because for applications relating to ASK or QAM constellations (e.g., that may be of interest in connection with 5G NR), a constant shift uniformly over all n and E does not change the net result of log Ñ^{[m]}(n, E). Additionally, some multiplicative constant may be used when doing a piecewise polynomial approximation. For example, instead of approximating logV^{[m]}(ω) in equation (12),

$$- \frac{1}{2} log V ( ω )$$

may be approximated directly, which may also reduce computational resources.

### Piecewise Polynomial Approximation

Again, and by way of example and not limitation, according to one aspect, piecewise polynomials may be used to approximate functions (of ω) in an approximation formula, such as formula (19), above. For example, piecewise polynomial approximations of the functions H, logV and Gᵢ for each involved i may be utilized.

For example, the interval [0, E(aₘ)] may be partitioned into K subintervals. The subintervals may be ordered and may be denoted by I₁, I₂, . . . , I_{K} herein. According to some aspects, both K and the subintervals I₁, I₂, . . . , I_{K} themselves may depend on the underlying function being approximated. This may be realized because, even when the number K of intervals for different functions are the same, the boundaries of the subintervals may be different for different functions being approximated, which results in different subintervals.

By way of another non-limiting example, one or more polynomials over each subinterval Iᵢ may be utilized. Accordingly, a subinterval Iᵢ may correspond to a polynomial of some degree dᵢ and may be expressed using, for example, the form:

$${p}_{i} ( ω ) = {\sum }_{j = 1}^{{d}_{i}} {a}_{j}^{( i )} {ω}^{j} . \qquad ( 20 )$$

According to some aspects, the coefficients aⱼ⁽ⁱ⁾ may be chosen (e.g., by numerical fitting) such that the value pᵢ(ω) is substantially similar (e.g., mathematically close) to the exact function value at ω.

According to some aspects, the polynomials pᵢ may depend on the underlying function being approximated, and the approximating function may be written as:

$${\sum }_{i = 1}^{K} {p}_{i} ( ω ) {𝕀}_{{I}_{i}} ( ω ) \qquad ( 21 )$$

where [symbol] is known as the indicator function, and [symbol] (ω)=1 if ω∈Iᵢ and 0 otherwise.

Some advantages of using piecewise polynomial approximations include the relative ease of the evaluation computations (e.g., computations of addition and multiplication are involved). Additionally, and as a further advantage, polynomials may be easily described. For example, to describe a given polynomial, only the coefficients and the corresponding degrees of the polynomial may need be stored.

Singularities aT 0 and E(aₘ) for H and logV

It may be observed that the functions H and logV exhibit known singularities at 0 and E(aₘ). For example, for the function H:

$$H ( ω ) ≃ - ω log ω + ω - \frac{1}{2} {ω}^{2} \qquad ( 22 )$$

for ω≈0. Additionally, and also for the function H:

$$H ( ω ) ≃ {h}_{2} ( \frac{E ( {a}_{m} ) - ω}{E ( {a}_{m} ) - E ( {a}_{m} )} ) \qquad ( 23 )$$

### for ω≈E(aₘ).

For example, for the function log V(ω):

$$log V ( ω ) ≃ log ω - ω \qquad ( 24 )$$

when ω≈0. Additionally, and also for the function log V(ω):

$$log V ( ω ) ≃ log ( E ( {a}_{m} ) - ω ) + log ( E ( {a}_{m} ) - E ( {a}_{m - 1} ) ) \qquad ( 25 )$$

when w≈E(aₘ).

The known singularities increase the complexity of approximating H and log V when ω is at or near 0 or E(aₘ). This implies more polynomial pieces (larger number of subintervals) may needed. Removing these singularities removes any difficulties related thereto. Therefore, removing these singularities reduces computational complexity in the computations of the approximations of H and log V.

### Variation on H and Log V

### Apply Piecewise Polynomial Approximations to Modified H log V

By way of example and not limitation, a first variation on the approximation of H and logV may include applying a piecewise polynomial approximation to modified H and logV. For example, consider the following functions on [0, E(aₘ)] as modified H and logV:

$$H ( ω ) + ω log ω + \frac{( E ( {a}_{m} ) - ω ) log ( E ( {a}_{m} ) - ω )}{E ( {a}_{m} ) - E ( {a}_{m - 1} )} \qquad ( 26 )$$

$$log V ( ω ) - log ω - log ( E ( {a}_{m} ) - ω ) . \qquad ( 27 )$$

Here, the notations p_{H} and p_{logV} may be used to denote the piecewise polynomial approximating functions of the above modified H (21) and logV (22), respectively. Using this process, the approximations of H and log V themselves may be determined by:

$$\hat{H} ( ω ) = {p}_{H} ( ω ) - ω log ω - \frac{( E ( {a}_{m} ) - ω ) log ( E ( {a}_{m} ) - ω )}{E ( {a}_{m} ) - E ( {a}_{m - 1} )} \qquad ( 28 )$$

$$( ω ) = {p}_{lo g V} ( ω ) + log ω + log ( E ( {a}_{m} ) - ω ) . \qquad ( 29 )$$

The processes described above may utilize evaluations of log ω and log(E(aₘ)−ω). These, of course, are logarithmic computations. However, for practical applications related to ASK or QAM constellations relevant to 5G NR, such as constellation shaping as described herein, only rational ω may be needed (i.e., where rational w is of the form

$$ω = \frac{E}{n} ) .$$

This may give rise to:

$$log ω = log E - log n \qquad ( 30 )$$

$$log ( E ( {a}_{m} ) - ω ) = log ( n E ( {a}_{m} ) - E ) - log n . \qquad ( 31 )$$

Accordingly, the approximation of H and log V based on the above may utilize logarithmic computations at integer values only.

### Apply Piecewise Polynomial Approximation to Modified H

According to still another aspect, a second variation on the approximation of H may be utilized. Namely, the application of a piecewise polynomial approximation to a modified H may be utilized. For example, the interval [0, E(aₘ)] may first be partitioned into three subintervals J_{L}, J_{M} and J_{R} (where L, M, and R stand for left, middle, and right, respectively). The subdivision into the three subintervals J_{L}, J_{M} and J_{R} may depend on the underlying function H being approximated. For example, the left boundary of J_{L} is 0 and the right boundary of J_{R} is E(aₘ).

According to this aspect, the following piecewise polynomial approximations to the following functions of the modified H on each of J_{L}, J_{M} and J_{R} may be realized:

$$\begin{matrix}H ( ω ) + ωlogω & ( over {J}_{L} )\end{matrix} \qquad ( 32 )$$

$$\begin{matrix}H ( ω ) & ( over {J}_{M} )\end{matrix} \qquad ( 33 )$$

$$H ( ω ) + \begin{matrix}\frac{( E ( {a}_{m} ) - ω ) log ( E ( {a}_{m} ) - ω )}{E ( {a}_{m} ) - E ( {a}_{m - 1} )} & ( over {J}_{R} ) .\end{matrix} \qquad ( 34 )$$

Still further, denoting by L_{H}, M_{H} and R_{H} the resulting piecewise polynomial approximating functions of the above modified H, respectively, the approximation of H may thus be determined as:

$$\begin{matrix}\hat{H} ( ω ) = {L}_{H} ( ω ) - ωlogω & ( over {J}_{L} )\end{matrix} \qquad ( 35 )$$

$$\hat{H} ( ω ) = \begin{matrix}{M}_{H} ( ω ) & ( over {J}_{M} )\end{matrix} \qquad ( 36 )$$

$$\hat{H} ( ω ) = {R}_{H} ( ω ) - \begin{matrix}\frac{( E ( {a}_{m} ) - ω ) log ( E ( {a}_{m} ) - ω )}{E ( {a}_{m} ) - E ( {a}_{m - 1} )} & ( over {J}_{R} ) .\end{matrix} \qquad ( 37 )$$

Accordingly, over each of the subintervals J_{L}, J_{M} and J_{R}, the approximation Ĥ of H is a piecewise polynomial plus a given term (referred to herein as a special term, e.g., ω log ω in (35) or the ratio in (37)).

### Apply Piecewise Polynomial Approximation to Modified Log V

Similarly, and according to still another aspect, a second variation on the approximation of logV may be utilized. Namely, the application of a piecewise polynomial approximation to a modified log V may be utilized. Again, and for example, the interval [0, E(aₘ)] may first be partitioned into three subintervals J_{L}, J_{M} and J_{R} (where L, M, and R stand for left, middle, and right, respectively). The subdivision into the three subintervals J_{L}, J_{M} and J_{R} may depend on the underlying function log V being approximated. As before, the left boundary of J_{L} is 0 and the right boundary of J_{R} is E(aₘ).

According to this aspect, the following piecewise polynomial approximations to the following functions of the modified log V on each of J_{L}, J_{M} and J_{R} may be realized:

$$\begin{matrix}log V ( ω ) - log ω & ( over {J}_{L} )\end{matrix} \qquad ( 38 )$$

$$\begin{matrix}log V ( ω ) & ( over {J}_{M} )\end{matrix} \qquad ( 39 )$$

$$log V ( ω ) - \begin{matrix}log ( E ( {a}_{m} ) - ω ) & ( over {J}_{R} ) .\end{matrix} \qquad ( 40 )$$

Denoting by L_{logV}, M_{logV}, and R_{logV} the resulting piecewise polynomial approximating functions of the modified log V, respectively, the approximation of log V may then be determined by:

$$\begin{matrix}( ω ) = {L}_{log V} ( ω ) + log ω & ( over {J}_{L} )\end{matrix} \qquad ( 41 )$$

$$( ω ) = \begin{matrix}{M}_{log V} ( ω ) & ( over {J}_{M} )\end{matrix} \qquad ( 42 )$$

$$\begin{matrix}( ω ) = {R}_{log V} ( ω ) + log ( E ( {a}_{m} ) - ω ) & ( over {J}_{R} ) .\end{matrix} \qquad ( 43 )$$

Therefore, over each of the subintervals J_{L}, J_{M}, and J_{R}, the approximation [symbol] of log V is a piecewise polynomial plus a given term (referred to herein as a special term, e.g., like log ω in (41)).

### EXAMPLE 1

The following is an example of a piecewise polynomial approximation of H (w) and is presented for purposes of discussion and not limitation. The example considers a case of m=4, with symbol energies given as E(a₁)=0, E(a₂)=1, E(a₃)=3, and E(a₄)=6. A piecewise polynomial of degree three may be used to approximate H. The resulting approximation of H is denoted as Ĥ. In this example, the interval [0, 6] is partitioned into K=27 subintervals as shown in Table 2, below.

TABLE 2

| i | [kᵢ, k̅ᵢ) |
|---|---|
| 0 | [0, 6) |
| 1 | [6, 12) |
| 2 | [12, 15) |
| 3 | [15, 19) |
| 4 | [19, 24) |
| 5 | [24, 30) |
| 6 | [30, 37) |
| 7 | [37, 45) |
| 8 | [45, 55) |
| 9 | [55, 67) |
| 10 | [67, 81) |
| 11 | [81, 98) |
| 12 | [98, 119) |
| 13 | [119, 144) |
| 14 | [144, 172) |
| 15 | [172, 203) |
| 16 | [203, 234) |
| 17 | [234, 263) |
| 18 | [263, 288) |
| 19 | [288, 309) |
| 20 | [309, 326) |
| 21 | [326, 347) |
| 22 | [347, 363) |
| 23 | [363, 374) |
| 24 | [374, 380) |
| 25 | [380, 383) |
| 26 | [383, 384) |

The data presented in Table 2 may be expressed as:

$${⋃}_{i = 0}^{26} {2}^{- 6} [ {\underline{k}}_{i} , {\overline{k}}_{i} ) \qquad ( 44 )$$

where:
the subintervals are of the form Iᵢ=kᵢ, k̅ᵢ) such that k̅ᵢ₋₁=kᵢ;
the subintervals form a partition of [0, 6], where E(a₄)=6; and
the polynomial degrees dᵢ=3 for each i.

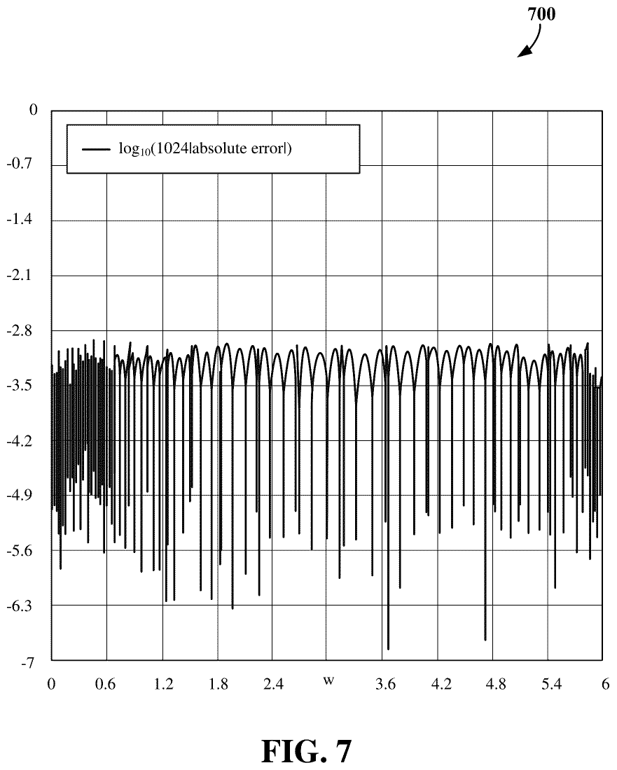

FIG. 7 is a graph 700 illustrating the accuracy of the piecewise polynomial approximation of H(_{w}) given in Example 1 according to some aspects of the disclosure. In greater detail, FIG. 7 depicts the logarithm of 1024 multiplied by the absolute error between the value of H(ω) and the value of the approximation of H(ω) (represented as Ĥ(ω)) under base 10 as a function of ω according to some aspects of the disclosure. The absolute value of this difference is mathematically expressed as |H(ω)−Ĥ(ω)|).

In the example of FIG. 7, an accuracy, uniformly over ω∈[1024⁻¹, 6−1024⁻¹], of |H(ω)−Ĥ(ω)|<10⁻⁶ is achieved. This implies that nH (@) achieves a worst-case approximation error of 10⁻³. Here, it was assumed the maximum n is 1024.

### EXAMPLE 2

The following example of a piecewise polynomial approximation of log V(ω) and is presented for purposes of discussion and not limitation. The example considers a case of m=4, with symbol energies given as E(a₁)=0, E(a₂)=1, E(a₃)=3, and E(a₄)=6. A piecewise polynomial of degree three may be used to approximate logV(ω). The resulting approximation is denoted as [symbol] . In this example, the interval [0, 6] is partitioned into K=9 subintervals as shown in Table 3, below.

TABLE 3

| i | [kᵢ, k̅ᵢ) |
|---|---|
| 0 | [0, 11) |
| 1 | [11, 31) |
| 2 | [31, 69) |
| 3 | [69, 141) |
| 4 | [141, 263) |
| 5 | [263, 328) |
| 6 | [328, 373) |
| 7 | [373, 381) |
| 8 | [381, 384) |

The data presented in Table 3 may be expressed as:

$${⋃}_{i = 0}^{9} {2}^{- 6} [ {\underline{k}}_{i} , {\overline{k}}_{i} ) \qquad ( 45 )$$

where:
the subintervals are of the form Iᵢ=[kᵢ, k̅ᵢ) such that k̅ᵢ₋₁=kᵢ;
the subintervals form a partition of [0, 6], where E(a₄)=6; and
the polynomial degrees dᵢ=3 for each i.

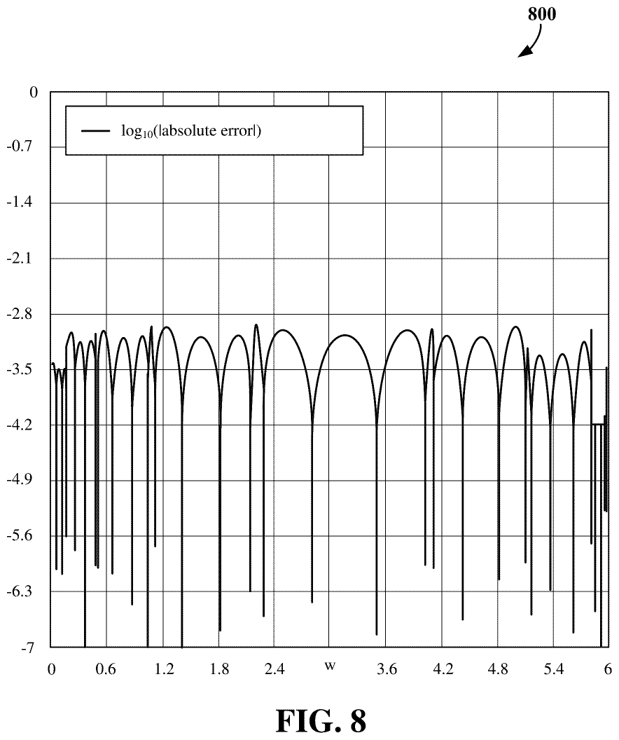

FIG. 8 is a graph 800 illustrating the accuracy of the piecewise polynomial approximation of logV(ω) given in Example 2 according to some aspects of the disclosure. In greater detail, FIG. 8 depicts the logarithm of the absolute error between the value of log V(ω) and the value of the approximation of logV(ω) (represented as [symbol] (ω) under base 10 as a function of ω according to some aspects of the disclosure. The absolute value of their difference is mathematically expressed as |logV(ω)− [symbol] (ω)|.

In the example of FIG. 8, an accuracy, uniformly over ω∈[1024⁻¹, 6−1024⁻¹], of |logV(ω)− [symbol] (ω)|<10⁻³ is achieved. This implies that logV(ω) achieves a worst-case approximation error of 10⁻³. Here, it was assumed the maximum n is 1024.

### EXAMPLE 3

In the following paragraphs, an example of a three-phase peeling distribution matching procedure, and a brief description of encoding utilizing three-phase peeling are described. The example is for purposes of discussion and not limitation. As described above, an approximation of N^{[m]}(n, E) may play a fundamental role in processes related to distribution matching (DM). In short, in the second phase of encoding, there may be a sequential procedure consisting of m−2 iterations with a specific initialization. During each iteration, an approximation of a logarithm of N^{[m]}(n, E) (i.e., log \hat{N}^{[m]}(n, E)) for some specific value of m and various values of n and E may be obtained. For each m, n and E, the exemplary approximation schemes described herein may be used to facilitate the computations involved in the second phase of encoding.

To set the stage, let [symbol] (m, n, [symbol] ) be the set of all symbol sequences of length n and over [symbol] , each sequence of which has energy at most equal to [symbol] (where [symbol] is a symbolic notation that may be used to represent the maximum energy or the maximum energy of symbol sequences of length n and over [symbol] ). The cardinality (e.g., the number of elements in a set) of the set [symbol] (m, n, [symbol] ) (i.e., the total number of symbol sequences in [symbol] (m, n, [symbol] )) may be denoted by:

$$\vert 𝒮 ( 𝔪 , 𝔫 , \overline{𝔈} ) \vert = {N}_{c}^{[ m ]} ( 𝔫 , \overline{𝔈} ) \qquad ( 46 )$$

Furthermore, let k be an integer such that:

$${2}^{- k} \geq \frac{1}{{N}_{c}^{[ m ]} ( 𝔫 , \overline{𝔈} )} . \qquad ( 47 )$$

At least one goal of three-phase peeling may be to realize the mapping induced by sphere shaping in a practical and efficient manner. Practical efficiency may be gained, for example, by finding effective and economical (e.g., in terms of time and power expended) ways to encode (e.g., map) length-k bit sequences into length-n symbol sequences in [symbol] (m, n, [symbol] ) and to guarantee unique decodability (e.g., unique decodability based on a one-to-one mapping of bit sequences to symbol sequences).

As an input, a bit sequence (u₁, u₂, . . . , uₖ), consisting of k information bits, symbol alphabet

$${𝒜}_{𝔪} ,$$

a symbol sequence length n, and maximum energy [symbol] are available for the encoding according to a three-phase peeling process. The input k-bit sequence is mapped to an output n-symbol sequence s=(s₁, s₂, . . . , sₙ)∈ [symbol] (m, n, [symbol] ) by the encoding associated with the three-phase peeling process. According to some aspects, the mapping from bit-sequences to symbol sequences may be injective (e.g., one-to-one).

There are 2^{k} possible choices of the k-bit sequence, i.e., the input is an arbitrary bit sequence; each such sequence is encoded to a unique output symbol sequence. The mapping from bit sequences to symbol sequences may be implicitly defined through an encoding procedure. Here, the encoding performs distribution matching because, in this example, the input bits are assumed to be uniformly distributed (with probability one-half for each value), while after the encoding, the distribution of the output symbols is non-uniform. The three phases of the three-phase peeling process are exemplified in the following paragraphs.

In one example, during a first phase, a device (e.g., a wireless communication device, a base station, a UE) may determine the energy, [symbol] , of the output length-n symbol sequence, where [symbol] is between 0 and [symbol] . In other words, without regard to the ultimate representation of the output length-n symbol sequence, the output length-n symbol sequence may be constrained to have the determined energy, [symbol] .

In this example, during a second phase, the device may determine a composition

$$( {k}_{1}^{*} , {k}_{2}^{*} , … , {k}_{𝔪}^{*} )$$

having the determined energy, [symbol] , where the determined energy, [symbol] , may be obtained from the first phase. Here, the symbol “*” is a symbolic notation meaning the target composition of the output length-n symbol sequence. The second phase may proceed in m−2 iterations.

In more detail, during the second phase, the device may initialize certain variables to the following values: j=0, nⱼ=n, Eⱼ= [symbol] . Here, j is an iteration step identifier, nⱼ is a residual length of the output symbol sequence at the beginning of iteration step j, and Eⱼ is a residual energy of the output symbol sequence at the beginning of the iteration step j. In this example, j increases by 1 in each iteration. During iteration j, the device may obtain (e.g., determine, compute) the following approximations:

$$log {\hat{N}}^{[ 𝔪 - j - 1 ]} ( {n}_{j} - {k}_{𝔪 - j} , {E}_{j} - {k}_{𝔪 - j} E ( {a}_{𝔪 - j} ) ) \qquad ( 48 )$$

for each kₘ₋ⱼ∈[kₘ₋ⱼ (nⱼ, Eⱼ), k̅ₘ₋ⱼ (nⱼ, Eⱼ)],
where: N^{[m-j-1]}(nⱼ−kₘ₋ⱼ, Eⱼ-kₘ₋ⱼE(aₘ₋ⱼ)) is the total number of symbol sequences over the alphabet [symbol] having alphabet size m−j−1, each respective symbol sequence having a symbol sequence length nⱼ−kₘ₋ⱼ and a symbol sequence energy Eⱼ−kₘ₋ⱼE(aₘ₋ⱼ), and kₘ₋ⱼ(⋅,⋅) and k̅ₘ₋ⱼ(⋅,⋅) may be predetermined functions that may be used to specify a range of kₘ₋ⱼ.

Based on these approximations and the input k-bit sequence, the device, at the second phase, may obtain (e.g., determine, compute)

$${k}_{𝔪 - j}^{*}$$

from the interval [kₘ₋ⱼ(nⱼ, Eⱼ), k̅ₘ₋ⱼ (nⱼ, Eⱼ)]. The device may then update the residual length,

$${n}_{j + 1} = {n}_{j} - {k}_{𝔪 - j}^{*}$$

and the residual energy, Eⱼ₊₁=Eⱼ−

$${k}_{m - j}^{*}$$

E(aₘ₋ⱼ). Note that the residual length decreases by

$${k}_{m - j}^{*}$$

and the residual energy decreases by

$${k}_{m - j}^{*} E ( {a}_{m - j} )$$

at each iteration. After this, the iteration step identifier j increases by 1.

The device may continue in this manner for all m−2 iterations as described above, so that

$${k}_{m}^{*} , {k}_{m - 1}^{*} , … , {k}_{3}^{*}$$

are all determined (these determine the numbers of occurrences of aₘ, aₘ₋₁, . . . , a₃, respectively).

Next,

$${k}_{1}^{*} and {k}_{2}^{*}$$

may be determined based on a length constraint

$$( e . g . , {k}_{1}^{*} + {k}_{2}^{*} = {n}_{m - 2} )$$

and an energy constraint

$$( e . g . , {k}_{1}^{*} E ( {a}_{1} ) + {k}_{2}^{*} E ( {a}_{2} ) = {E}_{m - 2} ) .$$

At the third phase, the device may determine an output sequence having the composition

$$( {k}_{1}^{*} , {k}_{2}^{*} , … , {k}_{m}^{*} )$$

obtained (e.g., determined) during the second phase, where the composition has energy, E, obtained (e.g., determined) during the first phase.

Aspects described herein may be examples of practical and efficient ways of accurately approximating expression (48). Aspects described herein may provide approximation schemes that may be used to practically and efficiently accurately approximate the expression (48) based on (19), that is, approximation schemes of the logarithm of the total number of symbol sequences over the alphabet [symbol] having alphabet size m−j−1, each respective symbol sequence having a symbol sequence length nⱼ−kₘ₋ⱼ and a symbol sequence energy Eⱼ−kₘ₋ⱼE(aₘ₋ⱼ)

According to aspects described herein, m, n and E in expressions (12) and (19) may be considered as function variables of log \hat{N}^{[m]}(n, E). Consequently, in the second phase of the encoding of three-phase peeling (described above), as j increases from 0 to m−2, the aspects described herein may be used to form the approximations Ĥ^{[m]}(ω), [symbol] ^{[m]}(ω) and Ĝᵢ^{[m]}(ω) and then log \hat{N}^{[m]}(n, E) as needed. According to aspects herein, during iteration j, a normalized energy, denoted by ω, may be determined as:

$$ω = \frac{{E}_{j} - {k}_{m - j} E ( {a}_{m - j} )}{{n}_{j} - {k}_{m - j}} \qquad ( 49 )$$

and may be used to search for subintervals to form piecewise polynomial approximations Ĥ^{[m-j-1]}(ω), [symbol] ^{[m-j-1]}(ω), and Ĝᵢ^{[m-j-1]}(ω).

As stated, during the second phase, and after obtaining the energy [symbol] that the output sequence should have (where the energy [symbol] is determined during the first phase), the device may determine the composition (k*₁, k*₂, . . . , k*ₘ) of the length-n symbol sequence having the determined energy, [symbol] . The device may determine the composition by determining a number of occurrences of each symbol from the alphabet [symbol] , where each element of the length-n symbol sequence belongs to the alphabet, [symbol] ={a₁, a₂, . . . , aₘ}.

As used herein, and as described above, the term “composition” refers to the number of occurrences. For example, the composition of the length 3 symbols sequence (1, 1, 3) is (2, 1), meaning that the number of occurrences of 1s is two while the number of occurrences of 3s is one. Broadly speaking, during the second phase, the device may sequentially determine all elements of the composition of the output sequence, where in each of m−2 iterations, a single element is determined. The determination may involve a plurality of approximations, each approximation being an approximation of a logarithm of a total number of symbol sequences over an alphabet having an alphabet size smaller than or equal to m, each respective symbol sequence having a symbol sequence length smaller than or equal to n, and a symbol sequence energy smaller than or equal to [symbol] .

In the third phase, the device may determine the output sequence having the composition obtained during the second phase.

### Storage of Piecewise Polynomials

According to another aspect, a polynomial index and type indicator may be stored. For example, for each function H, logV, and Gᵢs, a piecewise polynomial approximation may be applied as described above. Each subinterval Iᵢ may be associated with a polynomial index i and associated with a type indicator t. The type indicator may indicate which special term needs to be added to the polynomial evaluation.

For example, for logV, a type indicator t∈{0, 1, 2} such that the following holds:
0 corresponds to adding log ω to the polynomial evaluation (e.g., this may mean that ω∈J_{L});
1 corresponds to adding nothing to the polynomial evaluation (e.g., this may mean that ω∈J_{M}); and
2 corresponds to adding log(E(aₘ)−ω) to the polynomial evaluation (e.g., this may mean that ω∈J_{R}).

The polynomial indices and type indicators may be stored using a binary tree structure. Each internal node may store one key that corresponds to a subinterval boundary. The subinterval boundaries may have special structure, e.g., they may be dyadic numbers. Each leaf node may store two keys, the polynomial index and the type indicator associated to a subinterval. The binary tree structure may be constructed such that traversing a path from the root to a leaf mimics a binary search for a subinterval that includes ω.

According to another aspect, polynomial coefficients may be stored. For example, a look-up table may be used to store the polynomial coefficients of a piecewise polynomial. The polynomial indices may be used for table look-ups. Polynomial coefficients may be stored in different forms depending on implementation. Implementations may include, for example, truncated precision of real-valued coefficients or dyadic number approximation.

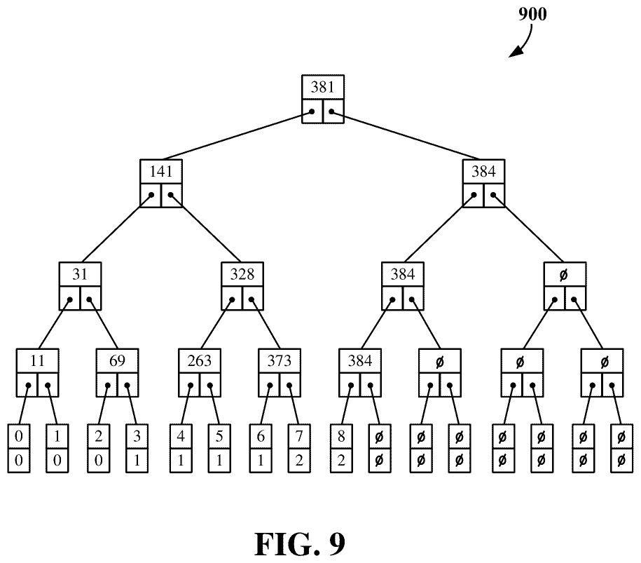

FIG. 9 is one example of a binary tree structure 900 for log V according to some aspects of the disclosure. In this example, an interval is partitioned into K=9 subintervals as shown in Table 3, above.

Each internal node stores one key, which corresponds to an interval boundary. Each leaf node stores two keys, depicted as one above the other, which correspond to a polynomial index value and a type indicator, respectively. For example, at the bottom of FIG. 9, the polynomial index values shown are 0, 1, 2, 3, 4, 5, 6, 7, and 8, and the type indicator values shown are 0, 1, 2. In this example, 0 corresponds to “+logω,” 1 corresponds to “+0,” and 2 corresponds to “+log(6−ω)).”

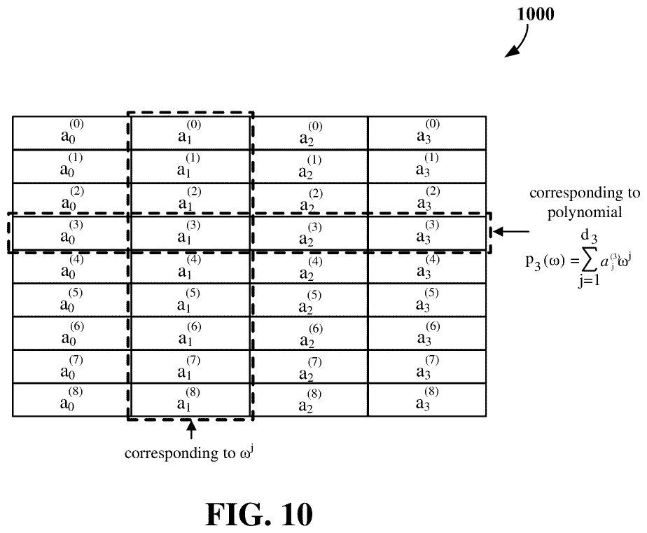

According to another example, a look-up table may store polynomial coefficients. By way of example and not limitation, FIG. 10 provides one example of a look-up table 1000 storing polynomial coefficients for logV according to some aspects of the disclosure. The look-up table has nine rows and 4 columns. Each row corresponds to the polynomial coefficients of the polynomial corresponding to some subinterval. Each column corresponds to a power of ω.

According to another aspect, a processing circuit may access polynomial indexes, type indicators, and/or polynomial coefficients and may evaluate polynomial approximations and/or approximations of logN(n, E).

For example, given E and n, a processing circuit may compute

$$ω = \frac{E}{n} .$$

Then, for each binary tree structure (corresponding to H, logV, or Gᵢs), use ω to search for polynomial index and type indicator. This process may be referred to as “access and evaluation” herein. The process may include traversing a binary tree structure from the root node to a leaf node. At each node, the processing circuit may compare w with the key of that node. In response to ω being smaller than the key, the processing circuit may traverse to a left child node. In response to ω being larger than or equal to the key, then the processing circuit may traverse to the right child node.

If the subinterval boundaries are dyadic (i.e., where dyadic means something that consists of two parts) with some common base D for all functions, e.g., they are of the form:

$$[ \frac{\underline{k}}{{2}^{D}} , \frac{\overline{k}}{{2}^{D}} ) \qquad ( 50 )$$

then the keys of the internal nodes can be integer-valued, which corresponds to the numerator of a dyadic such number. In this case, the comparison is based on 2^{D}ω and the value of the keys.

Having obtained the polynomial index from traversing each respective binary tree structure, the processing circuit may obtain the polynomial coefficient and type indicator from the respective tree. This process may be referred to as “accessing the polynomial coefficients” herein.

Based on ω, the polynomial coefficients, and the type indicator, the processing circuit may form the approximate Ĥ(ω), [symbol] (ω), and Ĝᵢ(ω)s. This process may be referred to as “evaluation of the polynomial approximation” herein.

The resulting approximate Ĥ(ω), [symbol] (ω), and Ĝᵢ(ω)s may then be used to form an approximation of logN(n, E). This may be referred to as “evaluation of the logN(n, E) approximation” herein.

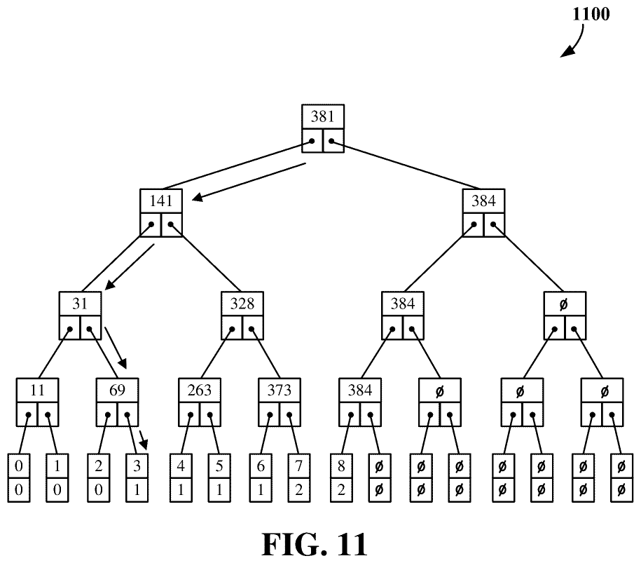

FIG. 11 provides one example of an access and evaluation process 1100 according to some aspects of the disclosure. FIG. 11 is identical to FIG. 9 and includes arrows to highlight the steps of traversing the binary tree structure as described below. As with FIG. 9, an interval is partitioned into K=9 subintervals as shown in Table 3, above. Assume that

$$\frac{{2}^{6} E}{n} = 70.375 ∈ [ 69 , 141 ) .$$

The search path for the polynomial index and type indicator begins at the root, with key value 381. The sought-after value is 70.375. The value 70.375 is less than 381, so the processing circuit traverses the binary tree structure to the left child node of the root. The left child node of the root has the key value of 141, so the processing circuit traverses the binary tree structure to the next left child. The next left child node has the key value of 31. The value of 70.375 is greater than 31, so the processing circuit traverses the binary tree structure to the next right leaf. The next right leaf has the key value of 69. The value of 70.375 is greater than 69, so the processing circuit again traverses the binary tree structure to the right, where it obtains the polynomial index value of 3 and the type indicator value of 1.

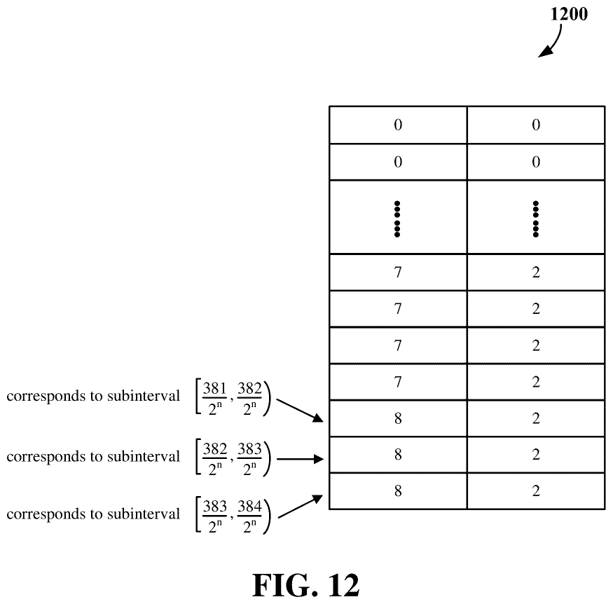

According to another aspect, an alternative way to store the polynomial index and type indicator is described. According to this aspect, for each function H, logV, and Gᵢs, a piecewise polynomial approximation may be applied as described above. Each subinterval Iᵢ may be associated with a polynomial index i and a type indicator t. As described above, the type indicator may indicate which special term needs to be added to the polynomial evaluation. The polynomial indices and type indicators for each case may be stored using a look-up table, such as the look-up table 1200 of FIG. 12. The look-up table 1200 may have 2^{D}E(aₘ) rows and 2 columns. The first column of each row may correspond to a polynomial index. The second column of each row may correspond to a type indicator.

The polynomial index and the type indicator of row K∈{0, 1, 2, . . . , 2^{D}E(aₘ)−1} corresponds to:

$$[ \frac{K}{{2}^{D}} , \frac{K + 1}{{2}^{D}} ) . \qquad ( 51 )$$

For the storage of the polynomial coefficients, the look-up table 1200 may be used to store the polynomial coefficients of a piecewise polynomial. The polynomial indices may therefore be used for table look-ups. Polynomial coefficients may be stored in different forms depending on implementation. For example, truncated precision of real-valued coefficients or dyadic number approximation forms may be stored.

FIG. 12 is one example of a look-up table 1200 for logV according to some aspects of the disclosure. Table 3 may be used in association with FIG. 12. The first two rows and the last seven rows of the look-up table 1200 for log V are shown in FIG. 12. The total number of rows in the running example is 6·2⁶=384. Therefore, the portion of the look-up table 1200 shown in FIG. 12 corresponds to the rows from index 0 to 1 and 377 to 383.

According to an alternative of the access and evaluation process described above, the following process may be implemented. First, given E and n, compute:

$$K = ⌊ \frac{E}{n} {2}^{D} ⌋ . \qquad ( 52 )$$

Next, obtain the polynomial index and the type indicator at row K of each look-up table corresponding to a function to be approximated. Having obtained each polynomial index, next obtain the polynomial coefficients. This may be referred to as “access polynomial coefficients” herein. Based on ω and the polynomial coefficients and the type indicator, form the approximates Ĥ(ω), [symbol] (ω), and Ĝᵢ (ω)s. This may be referred to as “evaluation of polynomial approximation” herein.

The resulting approximates Ĥ(ω), [symbol] (ω), and Ĝᵢ (ω)s may then be used to form an approximation of logN(n, E). This may be referred to as an “evaluation of logN(n, E) approximation” herein.

In general, and according to aspects described herein, a processing circuit may be configured to obtain subintervals over which to form piecewise polynomial approximations of a plurality of terms. The processing circuit may be further configured to obtain, utilizing the piecewise polynomial approximations of the plurality of terms, an approximation of a total number of first symbol sequences over a first alphabet having a first alphabet size, each respective symbol sequence of the total number of first symbol sequences having a first symbol sequence length and a first symbol sequence energy. Still further, the processing circuit may obtain a bit sequence having a bit sequence length. Still further, the processing circuit may be configured to encode the bit sequence, utilizing the approximation of the total number of first symbol sequences, to a second symbol sequence over a second alphabet having a second alphabet size, the second symbol sequence having a second symbol sequence length and a second symbol sequence energy, and to transmit the second symbol sequence via a wireless transceiver. These and other aspects are described in connection with a description of a hardware implementation of a wireless communication device provided below.

### Exemplary Hardware Implementation

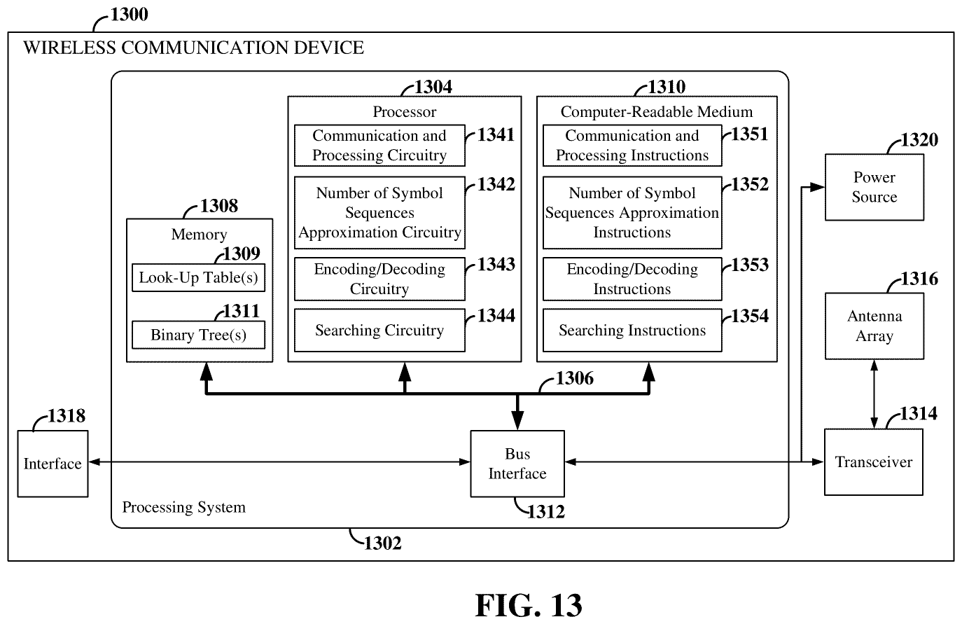

FIG. 13 is a block diagram illustrating an example of a hardware implementation of a wireless communication device 1300 employing a processing system 1302 according to some aspects of the disclosure. The wireless communication device 1300 may be a scheduling entity (e.g., a base station, an eNB, a gNB, a network access node) or a scheduled entity (e.g., a UE) as illustrated in any one or more of FIGS. 1 and/or 2.

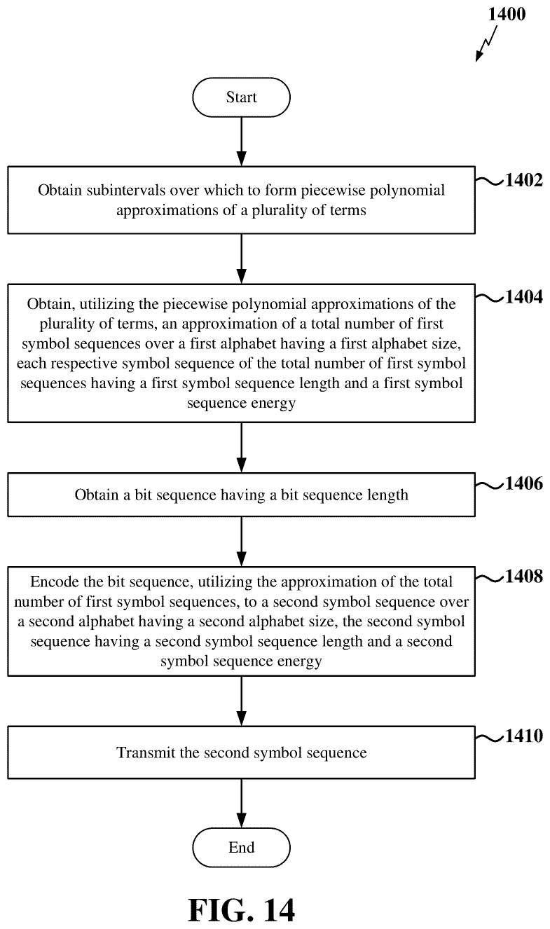

In accordance with various aspects of the disclosure, an element, or any portion of an element, or any combination of elements may be implemented with a processing system 1302 that includes one or more processors, such as processor 1304. Examples of processors 1304 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the wireless communication device 1300 may be configured to perform any one or more of the functions described herein. That is, the processor 1304, as utilized in the wireless communication device 1300, may be used to implement any one or more of the methods or processes described and illustrated, for example, in FIGS. 14 and/or 15.

The processor 1304 may in some examples be implemented via a baseband or modem chip and in other implementations, the processor 1304 may include a number of devices distinct and different from a baseband or modem chip (e.g., in such scenarios as may work in concert to achieve examples discussed herein). And as mentioned above, various hardware arrangements and components outside of a baseband modem processor can be used in implementations, including RF-chains, power amplifiers, modulators, buffers, interleavers, adders/summers, etc.

In this example, the processing system 1302 may be implemented with a bus architecture, represented generally by the bus 1306. The bus 1306 may include any number of interconnecting buses and bridges depending on the specific application of the processing system 1302 and the overall design constraints. The bus 1306 communicatively couples together various circuits, including one or more processors (represented generally by the processor 1304), a memory 1308, and computer-readable media (represented generally by the computer-readable medium 1310). The bus 1306 may also link various other circuits such as timing sources, peripherals, voltage regulators, and power management circuits, which are well known in the art, and therefore, will not be described any further.

A bus interface 1312 provides an interface between the bus 1306 and a transceiver 1314. The transceiver 1314 may be a wireless transceiver. The transceiver 1314 may provide a means for communicating with various other apparatus over a transmission medium (e.g., air interface). The transceiver 1314 may further be coupled to one or more antenna arrays (hereinafter antenna array 1316). The bus interface 1312 further provides an interface between the bus 1306 and a user interface 1318 (e.g., keypad, display, touch screen, speaker, microphone, control features, etc.). Of course, such a user interface 1318 is optional and may be omitted in some examples. In addition, the bus interface 1312 further provides an interface between the bus 1306 and a power source 1320 of the wireless communication device 1300.

The processor 1304 is responsible for managing the bus 1306 and general processing, including the execution of software stored on the computer-readable medium 1310. The software, when executed by the processor 1304, causes the processing system 1302 to perform the various functions described below for any particular apparatus. The computer-readable medium 1310 and the memory 1308 may also be used for storing data that is manipulated by the processor 1304 when executing software. The data may include data in look-up table(s) 1309, such as the look-up table(s) described above according to some aspects of the disclosure.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on the computer-readable medium 1310. When executed by the processor 1304, the software may cause the processing system 1302 to perform the various processes and functions described herein for any particular apparatus.

The computer-readable medium 1310 may be a non-transitory computer-readable medium and may be referred to as a computer-readable storage medium or a non-transitory computer-readable medium. The non-transitory computer-readable medium may store computer-executable code (e.g., processor-executable code). The computer-executable code may include code for causing a computer (e.g., a processor) to implement one or more of the functions described herein. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 1310 may reside in the processing system 1302, external to the processing system 1302, or distributed across multiple entities including the processing system 1302. The computer-readable medium 1310 may be embodied in a computer program product or article of manufacture. By way of example, a computer program product or article of manufacture may include a computer-readable medium in packaging materials. In some examples, the computer-readable medium 1310 may be part of the memory 1308. Those skilled in the art will recognize how best to implement the described functionality presented throughout this disclosure depending on the particular application and the overall design constraints imposed on the overall system.

In some aspects of the disclosure, the processor 1304 may include communication and processing circuitry 1341 configured for various functions, including, for example, communicating with other wireless communication devices (e.g., a scheduling entity, a scheduled entity), a network core (e.g., a 5G core network), or any other entity, such as, for example, local infrastructure or an entity communicating with the wireless communication device 1300 via the Internet, such as a network provider. In some examples, the communication and processing circuitry 1341 may include one or more hardware components that provide the physical structure that performs processes related to wireless communication (e.g., signal reception and/or signal transmission) and signal processing (e.g., processing a received signal and/or processing a signal for transmission including, but not limited to processing related to efficient and accurate approximation schemes in constellation shaping using functional fitting according to some aspects of the disclosure). For example, the communication and processing circuitry 1341 may include one or more transmit/receive chains.

In some implementations where the communication involves receiving information, the communication and processing circuitry 1341 may obtain or identify information from a component of the wireless communication device 1300 (e.g., from the transceiver 1314 that receives the information via radio frequency signaling or some other type of signaling suitable for the applicable communication medium), process (e.g., decode) the information, and output the processed information. For example, the communication and processing circuitry 1341 may output the information to another component of the processor 1304, to the memory 1308, or to the bus interface 1312. In some examples, the communication and processing circuitry 1341 may receive one or more of: signals, messages, other information, or any combination thereof. In some examples, the communication and processing circuitry 1341 may receive information via one or more channels. In some examples, the communication and processing circuitry 1341 may include functionality for a means for receiving. In some examples, the communication and processing circuitry 1341 may include functionality for a means for processing, including a means for demodulating, a means for decoding, etc.

In some implementations where the communication involves sending (e.g., transmitting) information, the communication and processing circuitry 1341 may obtain or identify information (e.g., from another component of the processor 1304, the memory 1308, or the bus interface 1312), process (e.g., modulate, encode, etc.) the information, and output the processed information. For example, the communication and processing circuitry 1341 may obtain data from look-up table(s) 1309 stored in the memory 1308 and may process the obtained data according to some aspects of the disclosure. For example, the communication and processing circuitry 1341 may obtain information and may output the information to the transceiver 1314 (e.g., that transmits the information via radio frequency signaling or some other type of signaling suitable for the applicable communication medium). In some examples, the communication and processing circuitry 1341 may send one or more of signals, messages, other information, or any combination thereof. In some examples, the communication and processing circuitry 1341 may send information via one or more channels. In some examples, the communication and processing circuitry 1341 may include functionality for a means for sending (e.g., a means for transmitting). In some examples, the communication and processing circuitry 1341 may include functionality for a means for generating, including a means for modulating, a means for encoding, etc. In some examples, the communication and processing circuitry 1341 may be configured to receive and process uplink traffic and uplink control messages (e.g., similar to uplink traffic 116 and uplink control 118 of FIG. 1) and process and transmit downlink traffic and downlink control messages (e.g., similar to downlink traffic 112 and downlink control 114 of FIG. 1) via the antenna array 1316 and the transceiver 1314. The communication and processing circuitry 1341, in combination with the transceiver 1314, may be configured to transmit a respective symbol sequence via the wireless transceiver.

The communication and processing circuitry 1341 may further be configured to execute communication and processing instructions 1351 (e.g., software) stored on the computer-readable medium 1310 to implement one or more functions described herein.

In some aspects of the disclosure, the processor 1304 may include a number of symbol sequences approximation circuitry 1342 (e.g., approximation of N^{[m]}(n, E) circuitry or log\hat{N}^{[m]}(n, E) circuitry). The number of symbol sequences approximation circuitry 1342 may be configured for various functions, including, for example, obtaining subintervals over which to form piecewise polynomial approximations of a plurality of terms, and obtaining, utilizing the piecewise polynomial approximations of the plurality of terms, an approximation of a total number of first symbol sequences over a first alphabet having a first alphabet size, each respective symbol sequence of the total number of first symbol sequences having a first symbol sequence length and a first symbol sequence energy. According to some aspects, the number of symbol sequences approximation circuitry 1342 may be further configured to obtain a normalized energy corresponding to a ratio of the first symbol sequence energy and the first symbol sequence length, and still further configured to utilize the normalized energy to obtain the subintervals. According to some aspects, the piecewise polynomial approximations of the plurality of terms may include at least one of: a first piecewise polynomial approximation of an entropy function, a second piecewise polynomial approximation of a logarithm of a variance function, and a respective piecewise polynomial approximation corresponding to each of one or more additional functions. In some examples, each of the at least one of the first piecewise polynomial approximation (of the entropy function), the second piecewise polynomial approximation (of the logarithm of the variance function), and the at least one respective piecewise polynomial approximation (corresponding to each of the one or more additional functions may be functions of a normalized energy). In some examples, the normalized energy may be equal to the ratio of the first symbol sequence energy and the first symbol sequence length. In some examples, the approximation of the total number of first symbol sequences may be based on a weighted sum of the piecewise polynomial approximations of the plurality of terms. Using expression (19) for illustrative and non-limiting purposes, it may be observed that Ĥ(ω) is weighted by (e.g., is multiplied by) n and Ĝᵢ (ω) is weighted by (e.g., is multiplied by)

$$\frac{1}{{n}^{i}}$$

(i.e., a term that is the inverse of a power of n). Here, n may refer to the first symbol sequence length. The plurality of terms may include at least one of: an entropy function, a variance function, and one or more additional functions.

According to some aspects, each respective piecewise polynomial approximation of the piecewise polynomial approximations of the plurality of terms may be evaluated over an interval having a first boundary (e.g., a left boundary) of zero and a second boundary (e.g., a right boundary) of a maximum energy symbol in the first alphabet. In some examples, the interval may be partitioned into a plurality of subintervals and each of the plurality of subintervals may be based on an underlying function of a respective term of the plurality of terms that is being approximated. According to some aspects, each of the plurality of subintervals may be associated with a respective polynomial index value of a plurality of polynomial index values, and a respective type indicator of a plurality of type indicators. The plurality of polynomial index values and the plurality of type indicators may be stored in the memory (such as, for example, memory 1308 of the wireless communication device 1300 as shown and described in connection with FIG. 13). The plurality of polynomial index values and the plurality of type indicators may be stored in the memory as a binary tree structure having a root, a plurality of internal nodes, and a plurality of leaf nodes. In some examples, each of the plurality of internal nodes may store one key corresponding to a subinterval boundary, and each of the plurality of leaf nodes may store two keys corresponding to the respective polynomial index value and the respective type indicator of a given subinterval. In some examples, each subinterval boundary may correspond to a dyadic number, and traversing a path of the binary tree structure from the root to a leaf node of the plurality of leaf nodes may correspond to a performance of a binary search for a subinterval that includes a value of a normalized energy. The binary search may be performed, for example, by traversing a path of the binary tree structure from the root to a leaf node of the plurality of leaf nodes. In some examples, each respective piecewise polynomial approximation may be comprised of a plurality of polynomial coefficients and a corresponding plurality of polynomial degrees, the plurality of polynomial coefficients and the corresponding plurality of polynomial degrees may be stored in the memory (such as, for example, memory 1308 of the wireless communication device 1300 as shown and described in connection with FIG. 13).

In some examples, the number of symbol sequences approximation circuitry 1342 (or more generally the processor 1304 and the memory 1308) may be configured to remove singularities from at least one respective piecewise polynomial approximation (e.g., of the plurality of underlying polynomial functions making up the approximation of N^{[m]}(n, E) (or the log\hat{N}^{[m]}(n, E))).

In some examples, the number of symbol sequences approximation circuitry 1342 may be further configured to obtain a normalized energy corresponding to a ratio of the first symbol sequence energy and the first symbol sequence length, and still further configured to locate the subintervals over which to form the piecewise polynomial approximations of the plurality of terms utilizing the normalized energy.

The number of symbol sequences approximation circuitry 1342 may further be configured to execute of number of symbol sequences approximation instructions 1352 (e.g., software) stored on the computer-readable medium 1310 to implement one or more functions described herein.

In some aspects of the disclosure, the processor 1304 may include encoding/decoding circuitry 1343, configured for various functions, including, for example, obtaining a bit sequence having a bit sequence length and encoding the bit sequence, utilizing the approximation of the total number of first symbol sequences, to a second symbol sequence over a second alphabet having a second alphabet size and having a second symbol sequence length and a second symbol sequence energy, and transmitting the second symbol sequence. The second symbol sequence may be transmitted via the transceiver 1314 and antenna array 1316 according to some aspects.

In some examples, the bit sequence may include a plurality of information bits and an encoding of the bit sequence to the second symbol sequence may be a distribution matching mapping that provides a one-to-one association between bit sequences and symbol sequences, including the bit sequence and the second symbol sequence, respectively. According to some examples, at least one of: the second respective symbol sequence may be an amplitude sequence, or the first alphabet may be a subset of or equal to the second alphabet. According to some examples, at least one of: the first symbol sequence length may be smaller than or equal to the second symbol sequence length, or the first symbol sequence energy may be smaller than or equal to the second symbol sequence energy.

In some aspects of the disclosure, the processor 1304 may include searching circuitry 1344, configured for various functions, including, for example, searching for a respective polynomial index value and a respective type indicator, based, for example, on an obtained normalized energy, utilizing a plurality of binary trees 1311 stored in the memory 1308. The plurality of binary trees 1311 may correspond to respective ones of a first approximation of an entropy function, a second approximation of a logarithm of a variance function, and a third approximation of one or more additional functions. In greater detail, the searching circuitry 1344 may be configured to traverse a given binary tree structure of the plurality of binary trees 1311 from a root to a first leaf node, compare, at the first leaf node, the value of the normalized energy to a key of the leaf node, and in response to the normalized energy being smaller than the key, traverse to a first child node that is to a left of the leaf node, or in response to the normalized energy being larger than or equal to the key, traverse to a second child node that is to a right of the leaf node. Still further the searching circuitry 1344 may be configured to continue the comparing and traversing until a last leaf node without a child node is identified and to then read (e.g., obtain) the respective polynomial index value and the respective type indicator from the last leaf node, and obtain the polynomial coefficient associated with of the first approximation of the entropy function, the second approximation of the logarithm of the variance function, and the third approximation of the one or more additional functions from the memory 1308 based on the respective polynomial index and the respective type indicator. The searching circuitry 1344 may further be configured to execute searching instructions 1354 (e.g., software) stored on the computer-readable medium 1310 to implement one or more functions described herein.

### Exemplary Processes

FIG. 14 is a flow chart illustrating an exemplary process 1400 (e.g., a method of wireless communication) at a wireless communication device (e.g., a scheduling entity, a scheduled entity) in a wireless communication network according to some aspects of the disclosure. As described below, some or all illustrated features may be omitted in a particular implementation within the scope of the present disclosure, and some illustrated features may not be required for all implementations. In some examples, the process 1400 may be carried out by the wireless communication device 1300 described and illustrated in connection with FIG. 13. In some examples, the process 1400 may be carried out by any suitable apparatus or means for carrying out the functions or algorithms described herein.

At block 1402, the wireless communication device may obtain subintervals over which to form piecewise polynomial approximations of a plurality of terms. According to some aspects, the piecewise polynomial approximations of the plurality of terms may include at least one of: a first piecewise polynomial approximation of an entropy function, a second piecewise polynomial approximation of a logarithm of a variance function, and a respective piecewise polynomial approximation corresponding to each of one or more additional functions. Additionally, each of the at least one of the first piecewise polynomial approximation, the second piecewise polynomial approximation, and the at least one respective piecewise polynomial approximation may be functions of a normalized energy.

According to some aspects, each respective piecewise polynomial approximation may include a plurality of polynomial coefficients and a corresponding plurality of polynomial degrees. The plurality of polynomial coefficients and the corresponding plurality of polynomial degrees being stored in a memory, such as the memory 1308 as shown and described in connection with FIG. 13, of the wireless communication device. According to some aspects, each respective piecewise polynomial approximation of the piecewise polynomial approximations of the plurality of terms may be evaluated over an interval having a first boundary of zero and a second boundary of a maximum energy symbol in the first alphabet. The interval may be partitioned into a plurality of subintervals and each of the plurality of subintervals may be based on an underlying function of a respective term of the plurality of terms that is being approximated.

According to some aspects, each subinterval of the plurality of subintervals may be associated with a respective polynomial index value of a plurality of polynomial index values, and a respective type indicator of a plurality of type indicators. Furthermore, the plurality of polynomial index values and the plurality of type indicators may be stored as a binary tree structure having a root, a plurality of internal nodes, and a plurality of leaf nodes. The binary tree structure may be stored in a memory of the wireless communication device, such as the memory 1308 as shown and described in connection with FIG. 13. According to some aspects, each of the plurality of internal nodes may store one key corresponding to a subinterval boundary, and each of the plurality of leaf nodes may store two keys corresponding to the respective polynomial index value and the respective type indicator of a given subinterval.

In some examples, each subinterval boundary may correspond to a dyadic number. According to such aspects, process of FIG. 14 may also include performing a binary search for a subinterval that includes a value of a normalized energy by traversing a path of the binary tree structure from the root to a leaf node of the plurality of leaf nodes. According to some examples, the wireless communication device may remove singularities from at least one respective piecewise polynomial approximation.

For example, the communication and processing circuitry 1341, shown and described above in connection with FIG. 13, may provide a means for obtaining subintervals over which to form piecewise polynomial approximations of a plurality of terms, and may also provide a means for performing a binary search for a subinterval that includes a value of a normalized energy by traversing a path of the binary tree structure from the root to a leaf node of the plurality of leaf nodes. Still further, the communication and processing circuitry 1341 may provide a means for removing singularities from at least one respective piecewise polynomial approximation.

At block 1404, the wireless communication device may obtain, utilizing the piecewise polynomial approximations of the plurality of terms, an approximation of a total number of first symbol sequences over a first alphabet having a first alphabet size, each respective symbol sequence of the total number of first symbol sequences having a first symbol sequence length and a first symbol sequence energy. According to some aspects, the approximation of the total number of first symbol sequences may be based on a weighted sum of the piecewise polynomial approximations of the plurality of terms. In some examples, the wireless communication device may obtain a normalized energy corresponding to a ratio of the first symbol sequence energy and the first symbol sequence length. The wireless communication device may locate the subintervals (e.g., the subintervals referred to at 1402) over which to form the piecewise polynomial approximations of the plurality of terms utilizing the normalized energy.

For example, the number of symbol sequences approximation circuitry 1342, shown and described above in connection with FIG. 13, in connection with, for example, the communication and processing circuitry 1341 and/or the memory 1308, may provide a means for obtaining, utilizing the piecewise polynomial approximations of the plurality of terms, an approximation of a total number of first symbol sequences over a first alphabet having a first alphabet size, each respective symbol sequence of the total number of first symbol sequences having a first symbol sequence length and a first symbol sequence energy. In some examples, the number of symbol sequences approximation circuitry 1342, shown and described above in connection with FIG. 13, in connection with, for example, the communication and processing circuitry 1341 and/or the memory 1308, may also provide a means for obtaining a normalized energy corresponding to a ratio of the first symbol sequence energy and the first symbol sequence length, and may additionally provide a means for locating the subintervals over which to form the piecewise polynomial approximations of the plurality of terms utilizing the normalized energy.

At block 1406, the wireless communication device may obtain a bit sequence having a bit sequence length. For example, the communication and processing circuitry 1341, shown and described above in connection with FIG. 13, may provide a means for obtaining a bit sequence having a bit sequence length.

At block 1408, the wireless communication device may encode the bit sequence, utilizing the approximation of the total number of first symbol sequences, to a second symbol sequence over a second alphabet having a second alphabet size and having a second symbol sequence length and a second symbol sequence energy. According to some aspects, the bit sequence may include a plurality of information bits, and the encoding of the bit sequence to the second symbol sequence may be a distribution matching mapping that provides a one-to-one association between bit sequences and symbol sequences including the bit sequence and the second symbol sequence, respectively. In some examples, the second symbol sequence may be an amplitude sequence. In some examples, the first alphabet may be a subset of or equal to the second alphabet. In some examples, the first symbol sequence length may be smaller than or equal to the second symbol sequence length. In some examples, the first symbol sequence energy may be smaller than or equal to the second symbol sequence energy. For example, the encoding/decoding circuitry 1343, shown and described in connection with FIG. 13, may provide a means for encoding the bit sequence, utilizing the approximation of the total number of first symbol sequences, to a second symbol sequence over a second alphabet having a second alphabet size and having a second symbol sequence length and a second symbol sequence energy.

At block 1410, the wireless communication device may transmit the second symbol sequence. According to some examples, the wireless communication device may transmit the second symbol sequence via a wireless transceiver. For example, the transceiver 1314, shown and described above in connection with FIG. 13, in connection with, for example, the antenna array 1316 and/or the communication and processing circuitry 1341, may provide a means for transmitting the second symbol sequence via a wireless transceiver.

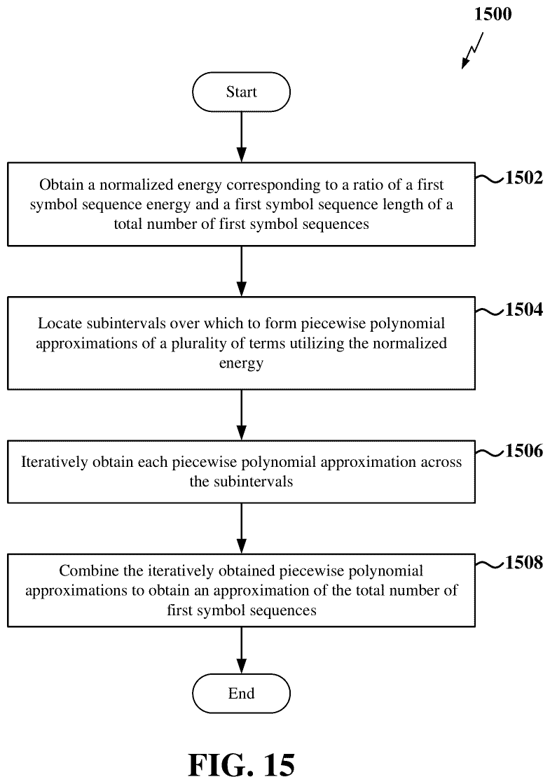

FIG. 15 is a flow chart illustrating an exemplary process 1500 (e.g., a method of wireless communication) at a wireless communication device (e.g., a scheduling entity, a scheduled entity) in a wireless communication network according to some aspects of the disclosure. As described below, some or all illustrated features may be omitted in a particular implementation within the scope of the present disclosure, and some illustrated features may not be required for all implementations. In some examples, the process 1500 may be carried out by the wireless communication device 1300 described and illustrated in connection with FIG. 13. In some examples, the process 1500 may be carried out by any suitable apparatus or means for carrying out the functions or algorithms described herein.

At block 1502, the wireless communication device may obtain a normalized energy corresponding to a ratio of a first symbol sequence energy and a first symbol sequence length of a total number of first symbol sequences. For example, the communication and processing circuitry 1341, shown and described above in connection with FIG. 13, may provide a means for obtaining a normalized energy corresponding to a ratio of a first symbol sequence energy and a first symbol sequence length of a total number of first symbol sequences.

At block 1504, the wireless communication device may locate subintervals over which to form piecewise polynomial approximations of a plurality of terms utilizing the normalized energy. For example, the communication and processing circuitry 1341, shown and described above in connection with FIG. 13, may provide a means for locating subintervals over which to form piecewise polynomial approximations of a plurality of terms utilizing the normalized energy.

At block 1506, the wireless communication device may iteratively obtain each piecewise polynomial approximation across the subintervals. For example, the number of symbol sequences approximation circuitry 1342, may provide a means for iteratively obtaining each piecewise polynomial approximation across the subintervals.

At block 1508, the wireless communication device may combine the iteratively obtained piecewise polynomial approximations to obtain an approximation of the total number of first symbol sequences. For example, the number of symbol sequences approximation circuitry 1342, may provide a means for combining the iteratively obtained piecewise polynomial approximations to obtain an approximation of the total number of first symbol sequences.

Of course, in the above examples, the circuitry included in the processor 1304 of FIG. 13 is merely provided as an example. Other means for carrying out the described functions may be included within various aspects of the present disclosure, including but not limited to the instructions stored in the computer-readable medium 1310 or any other suitable apparatus or means described in any one of the FIGS. 1, 2, and/or 4 and utilizing, for example, the processes and/or algorithms described herein including those depicted in relation to FIGS. 14 and/or 15.

### EXEMPLARY ASPECTS OF THE DISCLOSURE

The following provides an overview of aspects of the present disclosure:

Aspect 1: A wireless communication device, comprising: a wireless transceiver, a memory, and a processor coupled to the wireless transceiver and the memory, the processor and the memory being configured to: obtain subintervals over which to form piecewise polynomial approximations of a plurality of terms; obtain, utilizing the piecewise polynomial approximations of the plurality of terms, an approximation of a total number of first symbol sequences over a first alphabet having a first alphabet size, each respective symbol sequence of the total number of first symbol sequences having a first symbol sequence length and a first symbol sequence energy, obtain a bit sequence having a bit sequence length, encode the bit sequence, utilizing the approximation of the total number of first symbol sequences, to a second symbol sequence over a second alphabet having a second alphabet size, the second symbol sequence having a second symbol sequence length and a second symbol sequence energy, and transmit the second symbol sequence via the wireless transceiver.

Aspect 2: The wireless communication device of aspect 1, wherein the processor and the memory are further configured to: obtain a normalized energy corresponding to a ratio of the first symbol sequence energy and the first symbol sequence length, and locate the subintervals over which to form the piecewise polynomial approximations of the plurality of terms utilizing the normalized energy.

Aspect 3: The wireless communication device of aspect 1 or aspect 2, wherein: the bit sequence includes a plurality of information bits, and an encoding of the bit sequence to the second symbol sequence is a distribution matching mapping that provides a one-to-one association between bit sequences and symbol sequences including the bit sequence and the second symbol sequence, respectively.

Aspect 4: The wireless communication device of any of aspects 1 through 3, wherein at least one of: the second symbol sequence is an amplitude sequence, or the first alphabet is a subset of or equal to the second alphabet.

Aspect 5: The wireless communication device of any of aspects 1 through 4, wherein at least one of: the first symbol sequence length is smaller than or equal to the second symbol sequence length, or the first symbol sequence energy is smaller than or equal to the second symbol sequence energy.

Aspect 6: The wireless communication device of any of aspects 1 through 5, wherein: the piecewise polynomial approximations of the plurality of terms comprise at least one of: a first piecewise polynomial approximation of an entropy function, a second piecewise polynomial approximation of a logarithm of a variance function, and a respective piecewise polynomial approximation corresponding to each of one or more additional functions, and each of the at least one of the first piecewise polynomial approximation, the second piecewise polynomial approximation, and the at least one respective piecewise polynomial approximation are functions of a normalized energy.

Aspect 7: The wireless communication device of any of aspects 1 through 6, wherein: the approximation of the total number of first symbol sequences is based on a weighted sum of the piecewise polynomial approximations of the plurality of terms.

Aspect 8: The wireless communication device of any of aspects 1 through 7, wherein: each respective piecewise polynomial approximation of the piecewise polynomial approximations of the plurality of terms is evaluated over an interval having a first boundary of zero and a second boundary of a maximum energy symbol in the first alphabet, the interval is partitioned into a plurality of subintervals; and each of the plurality of subintervals is based on an underlying function of a respective term of the plurality of terms that is being approximated.

Aspect 9: The wireless communication device of aspect 8, wherein: each of the plurality of subintervals is associated with: a respective polynomial index value of a plurality of polynomial index values, and a respective type indicator of a plurality of type indicators; the plurality of polynomial index values and the plurality of type indicators are stored as a binary tree structure having a root, a plurality of internal nodes, and a plurality of leaf nodes; each of the plurality of internal nodes stores one key corresponding to a subinterval boundary; and each of the plurality of leaf nodes stores two keys corresponding to the respective polynomial index value and the respective type indicator of a given subinterval.

Aspect 10: The wireless communication device of aspect 9, wherein the subinterval boundary corresponds to a dyadic number, and the processor and the memory are further configured to: perform a binary search for a subinterval that includes a value of a normalized energy by traversing a path of the binary tree structure from the root to a leaf node of the plurality of leaf nodes.

Aspect 11: The wireless communication device of any of aspects 1 through 10, wherein each respective piecewise polynomial approximation is comprised of a plurality of polynomial coefficients and a corresponding plurality of polynomial degrees, the plurality of polynomial coefficients and the corresponding plurality of polynomial degrees being stored in the memory.

Aspect 12: The wireless communication device of any of aspects 1 through 11, wherein the processor and the memory are further configured to: remove singularities from at least one respective piecewise polynomial approximation.

Aspect 13: A method at a wireless communication device, comprising: obtaining subintervals over which to form piecewise polynomial approximations of a plurality of terms; obtaining, utilizing the piecewise polynomial approximations of the plurality of terms, an approximation of a total number of first symbol sequences over a first alphabet having a first alphabet size, each respective symbol sequence of the total number of first symbol sequences having a first symbol sequence length and a first symbol sequence energy, obtaining a bit sequence having a bit sequence length, encoding the bit sequence, utilizing the approximation of the total number of first symbol sequences, to a second symbol sequence over a second alphabet having a second alphabet size and having a second symbol sequence length and a second symbol sequence energy; and transmitting the second symbol sequence.

Aspect 14: The method of aspect 13, further comprising: obtaining a normalized energy corresponding to a ratio of the first symbol sequence energy and the first symbol sequence length, and locating the subintervals over which to form the piecewise polynomial approximations of the plurality of terms utilizing the normalized energy.

Aspect 15: The method of aspect 13 or 14, wherein: the bit sequence includes a plurality of information bits, and the encoding of the bit sequence to the second symbol sequence is a distribution matching mapping that provides a one-to-one association between bit sequences and symbol sequences including the bit sequence and the second symbol sequence, respectively.

Aspect 16: The method of any of aspects 13 through 15, wherein at least one of: the second symbol sequence is an amplitude sequence, or the first alphabet is a subset of or equal to the second alphabet.

Aspect 17: The method of any of aspects 13 through 16, wherein at least one of: the first symbol sequence length is smaller than or equal to the second symbol sequence length, or the first symbol sequence energy is smaller than or equal to the second symbol sequence energy.

Aspect 18: The method of any of aspects 13 through 17, wherein: the piecewise polynomial approximations of the plurality of terms comprise at least one of: a first piecewise polynomial approximation of an entropy function, a second piecewise polynomial approximation of a logarithm of a variance function, and a respective piecewise polynomial approximation corresponding to each of one or more additional functions, and each of the at least one of the first piecewise polynomial approximation, the second piecewise polynomial approximation, and the at least one respective piecewise polynomial approximation are functions of a normalized energy.

Aspect 19: The method of any of aspects 13 through 18, wherein: the approximation of the total number of first symbol sequences is based on a weighted sum of the piecewise polynomial approximations of the plurality of terms.

Aspect 20: The method of any of aspects 13 through 19, wherein: each respective piecewise polynomial approximation of the piecewise polynomial approximations of the plurality of terms is evaluated over an interval having a first boundary of zero and a second boundary of a maximum energy symbol in the first alphabet, the interval is partitioned into a plurality of subintervals; and each of the plurality of subintervals is based on an underlying function of a respective term of the plurality of terms that is being approximated.

Aspect 21: The method of aspect 20, wherein: each of the plurality of subintervals is associated with: a respective polynomial index value of a plurality of polynomial index values, and a respective type indicator of a plurality of type indicators; the plurality of polynomial index values and the plurality of type indicators are stored as a binary tree structure having a root, a plurality of internal nodes, and a plurality of leaf nodes; each of the plurality of internal nodes stores one key corresponding to a subinterval boundary; and each of the plurality of leaf nodes stores two keys corresponding to the respective polynomial index value and the respective type indicator of a given subinterval.

Aspect 22: The method of aspect 21, wherein the subinterval boundary corresponds to a dyadic number, and the method further comprises: performing a binary search for a subinterval that includes a value of a normalized energy by traversing a path of the binary tree structure from the root to a leaf node of the plurality of leaf nodes.

Aspect 23: The method of any of aspects 13 through 22, wherein each respective piecewise polynomial approximation is comprised of a plurality of polynomial coefficients and a corresponding plurality of polynomial degrees, the plurality of polynomial coefficients and the corresponding plurality of polynomial degrees being stored in a memory of the wireless communication device.

Aspect 24: The method of any of aspects 13 through 23, further comprising: removing singularities from at least one respective piecewise polynomial approximation.

Aspect 25: A wireless communication device, comprising: means for obtaining subintervals over which to form piecewise polynomial approximations of a plurality of terms; means for obtaining, utilizing the piecewise polynomial approximations of the plurality of terms, an approximation of a total number of first symbol sequences over a first alphabet having a first alphabet size, each respective symbol sequence of the total number of first symbol sequences having a first symbol sequence length and a first symbol sequence energy, means for obtaining a bit sequence having a bit sequence length, means for encoding the bit sequence, utilizing the approximation of the total number of first symbol sequences, to a second symbol sequence over a second alphabet having a second alphabet size and having a second symbol sequence length and a second symbol sequence energy; and means for transmitting the second symbol sequence.

Aspect 26: The wireless communication device of aspect 25, further comprising: means for obtaining a normalized energy corresponding to a ratio of the first symbol sequence energy and the first symbol sequence length, and means for locating the subintervals over which to form the piecewise polynomial approximations of the plurality of terms utilizing the normalized energy.

Aspect 27: The wireless communication device of aspect 25 or 26, wherein at least one of: the second symbol sequence is an amplitude sequence, or the first alphabet is a subset of or equal to the second alphabet.

Aspect 28: The wireless communication device of any of aspects 25 through 27, wherein at least one of: the first symbol sequence length is smaller than or equal to the second symbol sequence length, or the first symbol sequence energy is smaller than or equal to the second symbol sequence energy.

Aspect 29: The wireless communication device of any of aspects 25 through 28, further comprising: means for performing a binary search for a subinterval that includes a value of a normalized energy by traversing a path of a binary tree structure from a root to a leaf node of a plurality of leaf nodes.

Aspect 30: The wireless communication device of any of aspects 25 through 29, further comprising: means for removing singularities from at least one respective piecewise polynomial approximation.

Several aspects of a wireless communication network have been presented with reference to an exemplary implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA 2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

### CONCLUSION

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage, or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-15 may be rearranged and/or combined into a single component, step, feature, or function or embodied in several components, steps, or functions. Additional elements, components, steps, and/or functions may also be added without departing from novel features disclosed herein. The apparatus, devices, and/or components illustrated in FIGS. 1-15 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order and are not meant to be limited to the specific order or hierarchy presented unless specifically recited therein. While some examples illustrated herein depict only time and frequency domains, additional domains such as a spatial domain are also contemplated in this disclosure.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. The construct A and/or B is intended to cover: A; B; and A and B. The word “obtain” as used herein may mean, for example, acquire, calculate, construct, derive, determine, receive, and/or retrieve. The preceding list is exemplary and not limiting. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112 (f) unless the element is expressly recited using the phrase “means for” or, in the case of a method claim, the element is recited using the phrase “step for.”

What is claimed is:

1. A wireless communication device, comprising:
a wireless transceiver;
a memory; and
a processor coupled to the wireless transceiver and the memory, the processor and the memory being configured to:
obtain subintervals over which to form piecewise polynomial approximations of a plurality of terms;
obtain, utilizing the piecewise polynomial approximations of the plurality of terms, an approximation of a total number of first symbol sequences over a first alphabet having a first alphabet size, each respective symbol sequence of the total number of first symbol sequences having a first symbol sequence length and a first symbol sequence energy;
obtain a bit sequence having a bit sequence length;
encode the bit sequence, utilizing the approximation of the total number of first symbol sequences, to a second symbol sequence over a second alphabet having a second alphabet size, the second symbol sequence having a second symbol sequence length and a second symbol sequence energy; and
transmit the second symbol sequence via the wireless transceiver.

2. The wireless communication device of claim 1, wherein the processor and the memory are further configured to:
obtain a normalized energy corresponding to a ratio of the first symbol sequence energy and the first symbol sequence length; and
locate the subintervals over which to form the piecewise polynomial approximations of the plurality of terms utilizing the normalized energy.

3. The wireless communication device of claim 1, wherein:
the bit sequence includes a plurality of information bits; and
an encoding of the bit sequence to the second symbol sequence is a distribution matching mapping that provides a one-to-one association between bit sequences and symbol sequences including the bit sequence and the second symbol sequence, respectively.

4. The wireless communication device of claim 1, wherein at least one of:
the second symbol sequence is an amplitude sequence, or
the first alphabet is a subset of or equal to the second alphabet.

5. The wireless communication device of claim 1, wherein at least one of:
the first symbol sequence length is smaller than or equal to the second symbol sequence length, or
the first symbol sequence energy is smaller than or equal to the second symbol sequence energy.

6. The wireless communication device of claim 1, wherein:
the piecewise polynomial approximations of the plurality of terms comprise at least one of:
a first piecewise polynomial approximation of an entropy function,
a second piecewise polynomial approximation of a logarithm of a variance function, and
a respective piecewise polynomial approximation corresponding to each of one or more additional functions, and
each of the at least one of the first piecewise polynomial approximation, the second piecewise polynomial approximation, and the at least one respective piecewise polynomial approximation are functions of a normalized energy.

7. The wireless communication device of claim 1, wherein:
the approximation of the total number of first symbol sequences is based on a weighted sum of the piecewise polynomial approximations of the plurality of terms.

8. The wireless communication device of claim 1, wherein:
each respective piecewise polynomial approximation of the piecewise polynomial approximations of the plurality of terms is evaluated over an interval having a first boundary of zero and a second boundary of a maximum energy symbol in the first alphabet;
the interval is partitioned into a plurality of subintervals; and
each of the plurality of subintervals is based on an underlying function of a respective term of the plurality of terms that is being approximated.

9. The wireless communication device of claim 8, wherein:
each of the plurality of subintervals is associated with:
a respective polynomial index value of a plurality of polynomial index values, and
a respective type indicator of a plurality of type indicators;
the plurality of polynomial index values and the plurality of type indicators are stored as a binary tree structure having a root, a plurality of internal nodes, and a plurality of leaf nodes;
each of the plurality of internal nodes stores one key corresponding to a subinterval boundary; and
each of the plurality of leaf nodes stores two keys corresponding to the respective polynomial index value and the respective type indicator of a given subinterval.

10. The wireless communication device of claim 9, wherein the subinterval boundary corresponds to a dyadic number, and the processor and the memory are further configured to:
perform a binary search for a subinterval that includes a value of a normalized energy by traversing a path of the binary tree structure from the root to a leaf node of the plurality of leaf nodes.

11. The wireless communication device of claim 1, wherein each respective piecewise polynomial approximation is comprised of a plurality of polynomial coefficients and a corresponding plurality of polynomial degrees, the plurality of polynomial coefficients and the corresponding plurality of polynomial degrees being stored in the memory.

12. The wireless communication device of claim 1, wherein the processor and the memory are further configured to:
remove singularities from at least one respective piecewise polynomial approximation.

13. A method at a wireless communication device, comprising:
obtaining subintervals over which to form piecewise polynomial approximations of a plurality of terms;
obtaining, utilizing the piecewise polynomial approximations of the plurality of terms, an approximation of a total number of first symbol sequences over a first alphabet having a first alphabet size, each respective symbol sequence of the total number of first symbol sequences having a first symbol sequence length and a first symbol sequence energy;
obtaining a bit sequence having a bit sequence length;
encoding the bit sequence, utilizing the approximation of the total number of first symbol sequences, to a second symbol sequence over a second alphabet having a second alphabet size and having a second symbol sequence length and a second symbol sequence energy; and
transmitting the second symbol sequence.

14. The method of claim 13, further comprising:
obtaining a normalized energy corresponding to a ratio of the first symbol sequence energy and the first symbol sequence length; and
locating the subintervals over which to form the piecewise polynomial approximations of the plurality of terms utilizing the normalized energy.

15. The method of claim 13, wherein:
the bit sequence includes a plurality of information bits; and
the encoding of the bit sequence to the second symbol sequence is a distribution matching mapping that provides a one-to-one association between bit sequences and symbol sequences including the bit sequence and the second symbol sequence, respectively.

16. The method of claim 13, wherein at least one of:
the second symbol sequence is an amplitude sequence, or
the first alphabet is a subset of or equal to the second alphabet.

17. The method of claim 13, wherein at least one of:
the first symbol sequence length is smaller than or equal to the second symbol sequence length, or
the first symbol sequence energy is smaller than or equal to the second symbol sequence energy.

18. The method of claim 13, wherein:
the piecewise polynomial approximations of the plurality of terms comprise at least one of:
a first piecewise polynomial approximation of an entropy function,
a second piecewise polynomial approximation of a logarithm of a variance function, and
a respective piecewise polynomial approximation corresponding to each of one or more additional functions, and
each of the at least one of the first piecewise polynomial approximation, the second piecewise polynomial approximation, and the at least one respective piecewise polynomial approximation are functions of a normalized energy.

19. The method of claim 13, wherein:
the approximation of the total number of first symbol sequences is based on a weighted sum of the piecewise polynomial approximations of the plurality of terms.

20. The method of claim 13, wherein:
each respective piecewise polynomial approximation of the piecewise polynomial approximations of the plurality of terms is evaluated over an interval having a first boundary of zero and a second boundary of a maximum energy symbol in the first alphabet;
the interval is partitioned into a plurality of subintervals; and
each of the plurality of subintervals is based on an underlying function of a respective term of the plurality of terms that is being approximated.

21. The method of claim 20, wherein:
each of the plurality of subintervals is associated with:
a respective polynomial index value of a plurality of polynomial index values, and
a respective type indicator of a plurality of type indicators;
the plurality of polynomial index values and the plurality of type indicators are stored as a binary tree structure having a root, a plurality of internal nodes, and a plurality of leaf nodes;
each of the plurality of internal nodes stores one key corresponding to a subinterval boundary; and
each of the plurality of leaf nodes stores two keys corresponding to the respective polynomial index value and the respective type indicator of a given subinterval.

22. The method of claim 21, wherein the subinterval boundary corresponds to a dyadic number, and the method further comprises:
performing a binary search for a subinterval that includes a value of a normalized energy by traversing a path of the binary tree structure from the root to a leaf node of the plurality of leaf nodes.

23. The method of claim 13, wherein each respective piecewise polynomial approximation is comprised of a plurality of polynomial coefficients and a corresponding plurality of polynomial degrees, the plurality of polynomial coefficients and the corresponding plurality of polynomial degrees being stored in a memory of the wireless communication device.

24. The method of claim 13, further comprising:
removing singularities from at least one respective piecewise polynomial approximation.

25. A wireless communication device, comprising:
means for obtaining subintervals over which to form piecewise polynomial approximations of a plurality of terms;
means for obtaining, utilizing the piecewise polynomial approximations of the plurality of terms, an approximation of a total number of first symbol sequences over a first alphabet having a first alphabet size, each respective symbol sequence of the total number of first symbol sequences having a first symbol sequence length and a first symbol sequence energy;
means for obtaining a bit sequence having a bit sequence length;
means for encoding the bit sequence, utilizing the approximation of the total number of first symbol sequences, to a second symbol sequence over a second alphabet having a second alphabet size and having a second symbol sequence length and a second symbol sequence energy; and
means for transmitting the second symbol sequence.

26. The wireless communication device of claim 25, further comprising:
means for obtaining a normalized energy corresponding to a ratio of the first symbol sequence energy and the first symbol sequence length; and
means for locating the subintervals over which to form the piecewise polynomial approximations of the plurality of terms utilizing the normalized energy.

27. The wireless communication device of claim 25, wherein at least one of:
the second symbol sequence is an amplitude sequence, or
the first alphabet is a subset of or equal to the second alphabet.

28. The wireless communication device of claim 25, wherein at least one of:
the first symbol sequence length is smaller than or equal to the second symbol sequence length, or
the first symbol sequence energy is smaller than or equal to the second symbol sequence energy.

29. The wireless communication device of claim 25, further comprising:
means for performing a binary search for a subinterval that includes a value of a normalized energy by traversing a path of a binary tree structure from a root to a leaf node of a plurality of leaf nodes.

30. The wireless communication device of claim 25, further comprising:
means for removing singularities from at least one respective piecewise polynomial approximation.
